(19) United States
(12) Patent Application Publication
(10) Pub. No.: US 2005/0239586 A1
(43) Pub. Date: Oct. 27, 2005

(54) Bed lift

(76) Inventor: Michael W. Nebel, Smith Center, KS (US)

Correspondence Address: DARBY & DARBY P.C., P. O. BOX 5257, NEW YORK, NY, 10150-5257, US

(21) Appl. No.: 10/833,887

(22) Filed: Apr. 27, 2004

(51) Int. Cl. F16H 7/00; F16H 7/12

(52) U.S. Cl. 474/58

(57) ABSTRACT

A bed lift mechanism includes a first gear assembly attached to one side of the bed including a pair of sprockets coupled to a pair of coupling gears that engage with track members mounted to the side wall of the toy trailer; a second gear assembly attached to another side of the bed including another pair of sprockets coupled to a pair of coupling gears that engage with track members mounted to the opposite side wall of the toy trailer. A drive mechanism transfers rotational motion to one of the sprockets in the first gear assembly, the sprockets in the first gear assembly being operatively coupled to each other. The rotational motion is transferred from the first gear assembly to one of the sprockets in the second gear assembly, the sprockets in the second gear assembly being operatively coupled to each other.

### TECHNICAL FIELD

The present invention relates to lift mechanisms, and more particularly, relates to a lift mechanism that moves a bed in a controlled manner from a lowered position to a raised position.

### BACKGROUND

Conventional recreational vehicles (RVs) are available in a number of different types depending upon the size requirements and other desires of the purchaser. For example, the purchaser or user can select an RV that is motorized and can be driven by itself or one can be selected that requires a tow vehicle to tow the RV. Consumers increasingly want additional, increased interior room and also want to be provided with additional options available with the RV. One option that has found increasing commonality in the recent years is the incorporation of a rear section of the RV for storing one or more all-terrain vehicles (ATVs), dirt bikes, or other types of all-terrain, off-road, and recreational vehicles or motorized equipment, such as lawn mowers, etc. The section for storing the ATVs can be incorporated into any number of different types of RVs including motor homes and fifth wheel trailer type RVs. An RV for storing ATVs is often referred to as a “toy trailer” or “toy hauler”.

The toy trailer can include all the amenities of a conventional RV. The rear section can be an entirely separate area that is divided from a living area by a wall and a door. The incorporation of furniture in the rear section of the toy trailer is desirable since it results in an increase in the available space for use as a living area after the ATVs have been unloaded. Oftentimes the toy trailer has a pull down bed, benches, or tables that can fold up, via hinges or other device, against the inside of the side walls of the rear section of the toy trailer. By mounting a pull down bed, bench, or table to the side walls of the rear section, the user can simply swing the bed, bench, or table down when desired. The pull down bed, benches, or tables can swing down after the ATVs have been removed from the toy trailer.

When the ATVs are to be loaded back into the toy trailer, the bed, bench, or table is placed back in its storage positions, thereby increasing the overall available interior space in the rear section of the toy trailer.

The bed, bench and table are typically mounted on the side walls of the rear section. However, each bed, bench, or table decreases the amount of available space in the rear section of the toy trailer, since they must be stored on the side walls alongside the ATVs. Thus, there is less space in the toy trailer to store the ATVs.

U.S. Pat. No. 5,092,650 relates to a bed stored in an overhead area of a front portion of an RV where the driver and passenger seating is located. The bed is lowered when the RV is parked. A motor and a pair of torque tubes are disposed parallel to two side rails of the bed frame and are coupled so that the motor and torque tubes rotate together. The torque tubes span the length of the bed between two end rails positioned near the respective side walls of the RV. The torque tubes, the motor, and the side rails of the bed frame take up a significant amount of space, thereby increasing the amount of space required for installing and operating the bed. Furthermore, there are several rotating components exposed underneath the bed, e.g., the torque tubes and the motor, that are a safety hazard since items can be caught between the rotating components, thereby preventing the use of the underside of the bed between the side rails as a storage area.

What has heretofore not been available is an alternative reliable lift mechanism for easily and smoothly moving the bed, bench, or table between the lowered position and the raised position and provides a large amount of storage space, while providing a small, motorized RV.

### SUMMARY

A bed lift mechanism, according to an embodiment of the present invention, is mounted to a support and raises and lowers a bed. The bed lift mechanism includes a first gear assembly attached to one side of the bed, and the first gear assembly includes a first sprocket, a second sprocket, and a coupling gear coupled to each of the first sprocket and the second sprocket. A drive mechanism transfers rotational motion to the first sprocket in the first gear assembly, while the first sprocket is operatively coupled to the second sprocket in the first gear assembly so that the rotational motion from first sprocket is transferred to the second sprocket. The bed lift mechanism also includes a second gear assembly attached to another side of the bed, and the second gear assembly includes a third sprocket, a fourth sprocket, and a coupling gear coupled to each of the third sprocket and the fourth sprocket. One of the sprockets in the first gear assembly is a selected sprocket that is operatively coupled to the third sprocket in the second gear assembly so that the rotational motion from the selected sprocket is transferred to the third sprocket. The third sprocket is operatively coupled to the fourth sprocket in the second gear assembly so that the rotational motion from the third sprocket is transferred to the fourth sprocket. The bed lift mechanism also includes a first frame assembly and a second frame assembly mounted to the support. The first frame assembly includes two track members coupled to the coupling gears in the first gear assembly, and the second frame assembly includes two track members coupled to the coupling gears of the second gear assembly. The first sprocket, the second sprocket, the third sprocket, and the fourth sprocket transfer the rotational motion to the respective coupling gears to controllably move the bed between a raised position and a lowered position.

According to another embodiment of the invention, the lift mechanism can include a connecting rod for transferring the rotational motion from one of the sprockets in the first gear assembly to the third sprocket in the second gear assembly.

According to another embodiment of the invention, the lift mechanism can include a first chain for transferring the rotational motion from the first sprocket to the second sprocket in the first gear assembly; and a second chain for transferring the rotational motion from the third sprocket to the fourth sprocket in the second gear assembly.

According to another embodiment of the invention, the lift mechanism can include a drive sprocket connected to a drive shaft of the drive mechanism; and a third chain for transferring the rotational motion from the drive sprocket to the first sprocket in the first gear assembly.

According to another embodiment of the invention, the lift mechanism can include a drive sprocket connected to a drive shaft of the drive mechanism; a first chain for transferring the rotational motion from the drive sprocket to the first sprocket in the first gear assembly and for transferring the rotational motion from the first sprocket to the second sprocket in the first gear assembly; and a second chain for transferring the rotational motion from the third sprocket to the fourth sprocket in the second gear assembly.

According to another embodiment of the invention, the connecting rod is enclosed within a side rail of the bed.

According to another embodiment of the invention, the support is a pair of opposing side walls in a toy trailer.

According to another embodiment of the invention, the bed lift mechanism can include a first cross bar supporting the first gear assembly; a second cross bar supporting the second gear assembly; and a pair of first guide blocks is mounted to the first cross bar and a pair of second guide blocks is mounted to the second cross bar, wherein one of the first guide blocks is coupled to one of the track members in the first frame assembly, one of the second guide blocks is coupled to one of the track members in the second frame assembly, and each of the first guide blocks and the second guide blocks slides on the respective track member.

According to another embodiment of the invention, the bed lift mechanism can include first gear covers extending from the first cross bar for covering the coupling gears of the first gear assembly and second gear covers extending from the second cross bar for covering the coupling gears of the second gear assembly.

According to another embodiment of the invention, the bed lift mechanism can include a storage compartment incorporated into a bed frame of the bed.

According to a further embodiment of the present invention, the bed lift mechanism is mounted to a support, controllably moves a bed, and includes at least one bracket mounted to a support; a drive mechanism mounted to the at least one bracket; at least one spool supported by the at least one bracket; and a first belt and a second belt wound onto the spool, the second belt overlapping the first belt, wherein an end of the first belt and an end of the second belt are secured to different locations of the bed, and the first belt and the second belts are wound or unwound from the spool under action of the drive mechanism to controllably move the bed between a raised position and a lowered position.

### BRIEF DESCRIPTION OF THE DRAWINGS

The foregoing and other features of the present invention will be more readily apparent from the following detailed description and drawings of the illustrative embodiments of the invention wherein like reference numbers refer to similar elements and in which:

FIG. 1 is a perspective view of a toy trailer with a chain-driven bed lift mechanism according to an embodiment of the present invention;

FIG. 2 is an exploded perspective view of a power side assembly of the chain-driven bed lift mechanism of FIG. 1;

FIG. 3 is an exploded perspective view of a second end of the power side assembly of the chain-driven bed lift mechanism of FIG. 1;

FIG. 4 is an exploded perspective view of a powerhead of the power side assembly of the chain-driven bed lift mechanism of FIG. 1;

FIG. 5 is an exploded perspective view of a powerhead of a slave side assembly of the chain-driven bed lift mechanism of FIG. 1;

FIG. 6A is a sectional perspective view of a top side of a first end of the power side assembly of the chain-driven bed lift mechanism of FIG. 1;

FIG. 6B is a sectional perspective view of a bottom side of the first end of the power side assembly of FIG. 6A;

FIG. 7 is a perspective view of a second end of the slave side assembly of the chain-driven bed lift mechanism of FIG. 1;

FIG. 8 is a side view of the power side assembly of the chain-driven bed lift mechanism of FIG. 1;

FIG. 9 is a perspective view of a storage compartment in the chain-driven bed lift mechanism of FIG. 1;

FIG. 10 is a perspective view of the toy trailer with a chain-driven bed lift mechanism according to another embodiment of the present invention;

FIG. 11 is a side view of the toy trailer with a chain-driven bed lift mechanism according to a further embodiment of the present invention;

FIG. 12 is a side view of a belt-driven bed lift mechanism in the toy trailer according to an embodiment of the present invention;

FIG. 13 is a perspective view of the belt-driven bed lift mechanism of FIG. 12;

FIG. 14 is an exploded perspective view of the belt-driven bed lift mechanism of FIG. 12;

FIG. 15 is an exploded sectional perspective view taken in section 15 of FIG. 14 of a drive mechanism mounted to a first end of the power side assembly of the belt-driven bed lift mechanism;

FIG. 16 is a sectional perspective view taken in section 16 of FIG. 14 of the first end of the power side assembly of the belt-driven bed lift mechanism;

FIG. 17 is an exploded perspective view of a first belt and a second belt wrapped around a drive shaft in the power side assembly of the belt-driven bed lift mechanism of FIG. 12;

FIG. 18 is a sectional perspective view taken in section 18 of FIG. 14 of a second end of the power side assembly of the belt-driven bed lift mechanism;

FIG. 19 is a perspective view of a first end of the slave side assembly of the belt-driven bed lift mechanism of FIG. 12;

FIG. 20 is a sectional side view taken in section 20 of FIG. 13 of a bed mounted to a power side assembly during the installation of the belt-driven bed lift mechanism;

FIG. 21 is a sectional side view taken in section 21 of FIG. 13 of the bed mounted to a slave side assembly during the installation of the belt-driven bed lift mechanism; and

FIG. 22 is a side view of the power side assembly of the belt-driven bed lift mechanism of FIG. 12.

### DETAILED DESCRIPTION OF PREFERRED EMBODIMENTS

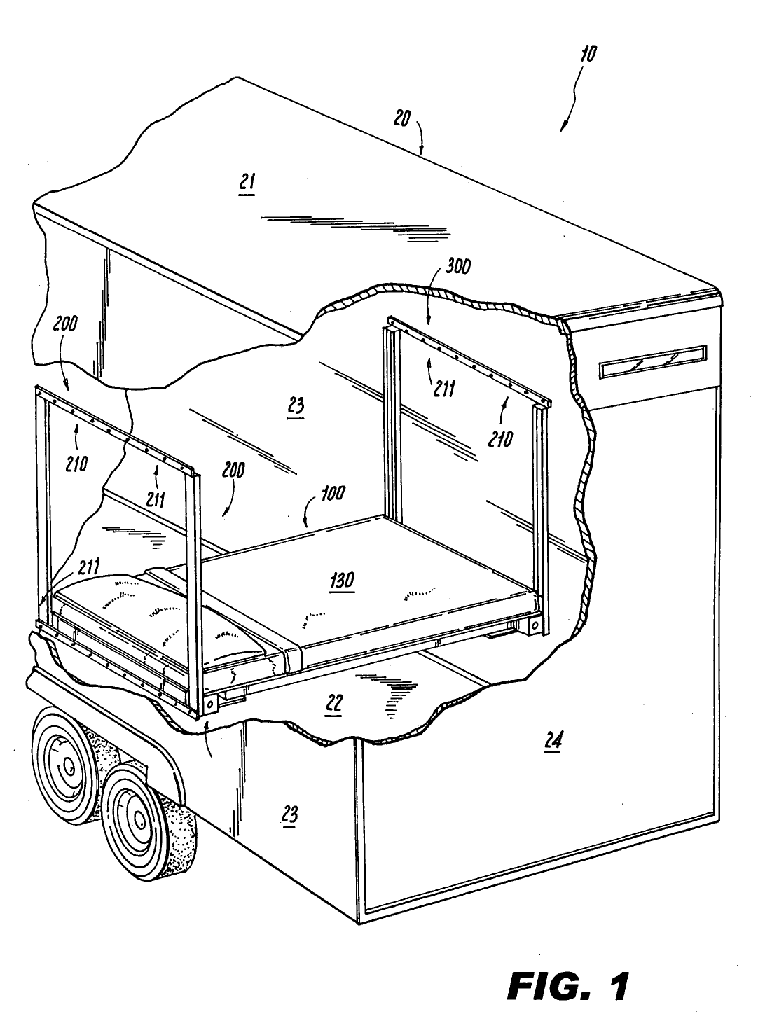

FIGS. 1-22 illustrate various embodiments of bed lift mechanisms in an exemplary toy trailer 10, which is an RV that has a rear section for storing one or more all-terrain vehicles (ATVs), dirt bikes, or other types of all-terrain, off-road, and recreational vehicles. or motorized equipment. The RV can be any type of RV including motor homes and fifth wheel trailer type RVs. An RV for storing ATVs is often referred to as a “toy trailer” or “toy hauler”.

The toy trailer typically includes a ramp (not shown) that opens into the rear section for allowing the ATVs to be loaded into the rear section of the toy trailer. The ramp drops down similarly to ramps in typical cargo trailers.

In most, if not all, toy trailers, a bed can be provided which can be raised and lowered over a height difference such as 9 feet. After the ATVs have been unloaded from the rear section of the toy trailer, the bed can be lowered and used for additional sleep accommodations. The ATVs can be loaded back into the rear section of the toy trailer when the beds are raised back into the original position.

There are a number of different type of RVs that can be adapted into a toy trailer depending upon a particular individual's needs, desires and wishes. For example, one type of RV is a motor home that is a self-contained motorized RV that looks something like a bus and is often referred to as a “coach”. This type of RV includes a number of different rooms and amenities that can provide superior comfort. Another type of RV is a travel trailer that is designed to be towed by a vehicle having hitch equipment for securely mating with the frame of the tow vehicle. Yet another type of RV is called a fifth wheel trailer (often referred to as a “fifth wheel”) which is a trailer that is designed to be towed by a vehicle, such as a pickup truck, that is equipped with a special hitch in a bed portion of the tow vehicle because of their layouts and constructions, fifth wheel vehicles are particularly suited for conversion to a toy trailer.

FIGS. 1-22 illustrate an RV adapted as a toy trailer 10; however, it will be understood that the present invention can be incorporated into various types of RVs, including those mentioned above. The toy trailer 10 includes a main cabin or housing (not shown), which includes the front portion of the toy trailer 10 and typically includes rooms, such as a master bedroom, kitchen, bathroom, closets, etc. A door (not shown) for entering the interior of the main cabin can be provided in this section.

The exemplary toy trailer 10 of FIGS. 1-22 has at least one lift mechanism 30 which is controllably movable from a raised position to a lowered position for the purpose of providing a bed 100 in the toy trailer 10 after the ATVs have been removed from a rear section 20 of the toy trailer 10. As shown in FIG. 1, the rear section 20 of the toy trailer 10 includes a ceiling section 21, a floor section 22, side walls 23, a front wall (not shown), a rear door 24, and a ramp (not shown) for loading and unloading the ATVs. The ramp can be dropped down to the ground after opening the rear door 24 and can be retracted back into the rear section 20 of the toy trailer 10 before closing the rear door 24.

The lift mechanism 30 functions as a mechanical drive mechanism for causing the controlled lifting and lowering of the bed 100. By actuating the lift mechanism, the bed 100 can be lowered from the raised position which is near the ceiling section 21 to the lowered position which is near the floor section 22 of the rear section 20 of the toy trailer 10. When the bed 100 is in the lowered position, the lift mechanism 30 can be actuated to raise the bed 100 from the lowered position to the raised position.

The bed lift mechanism 30 is incorporated into the rear section 20 of the toy trailer 10 for raising or lowering the bed 100; however, it is understood that the lift mechanism of the present invention is not limited to the rear section of a toy trailer but rather it can be incorporated into other rooms of the toy trailer, including those mentioned above.

The bed 100 includes a bed frame 110, a platform 120, and a mattress 130. The bed frame 110 includes a drive side rail 111, a side rail 112 parallel to the drive side rail 111 on the opposite side of the bed frame 110, and cross bars 113 connecting the rails 111, 112 and spanning the width of the bed frame 110. Rails 111, 112 and cross bars 113 serve as support members. The platform 120 is disposed on top of the rails 111, 112 and the cross bars 113, e.g., by being fastened to the tops of the rails 111, 112. The mattress 130 is placed on top of the platform 120; however, the mattress 130 can be removed to use the space for storage above the platform 120.

The platform 120 can be a section of plywood or some other type of sturdy, flat material fastened to the bed frame 110, so that the lift mechanism can be used to raise and lower the platform 120. Supplies and other items can be stored on the platform 120. Thus, it is understood that the lift mechanism of the present invention is not limited to being used as a personal bed but can be used as a storage shelf for lifting other types of loads.

The lift mechanism can be constructed in a number of different manners, using a number of different drive arrangements, including the following embodiments.

Chain-Driven Bed Lift Mechanism

FIGS. 1-9 illustrate an embodiment of a chain-driven bed lift mechanism 30, which is driven with one short chain 235 and a pair of long chains 236 to raise and lower the bed 100. It will be appreciated that each of the long and short chains can also be referred to as an endless, flexible drive member or element that mates with and is entrained over other drive members.

FIG. 1 is a perspective view of the toy trailer 10 with the chain-driven bed lift mechanism 30. The lift mechanism 30 includes a power side assembly 200 and a slave side assembly 300. The power and slave side assemblies 200, 300 are mounted to the opposite side walls 23 of the rear section 20 of the toy trailer 10.

The difference between the power side assembly 200 and the slave side assembly 300 is that the power side assembly 200 is directly connected to a drive mechanism 40, such as a worm gear assembly with a manual hand crank, a motor, or a motor with a manual override. The manual override can be a worm gear assembly as a self-locking system that eliminates the need for a break on the motor to keep the bed 100 from drifting down.

The slave side assembly 300 is not connected directly to the drive mechanism 40 and is instead driven directly by the power side assembly 200. A telescoping shaft 31 is extended or retracted to be able to connect to both of the power side assembly 200 and the slave side assembly 300. The length of the telescoping shaft 31 can be adjusted so that bed frames 110 of varying length can be mounted to the power side assembly 200 and the slave side assembly 300. The advantage of using a telescoping shaft is that it permits only one shaft to be manufactured or produced that is sized to fit and work well in a number of different bed assemblies of different dimensions.

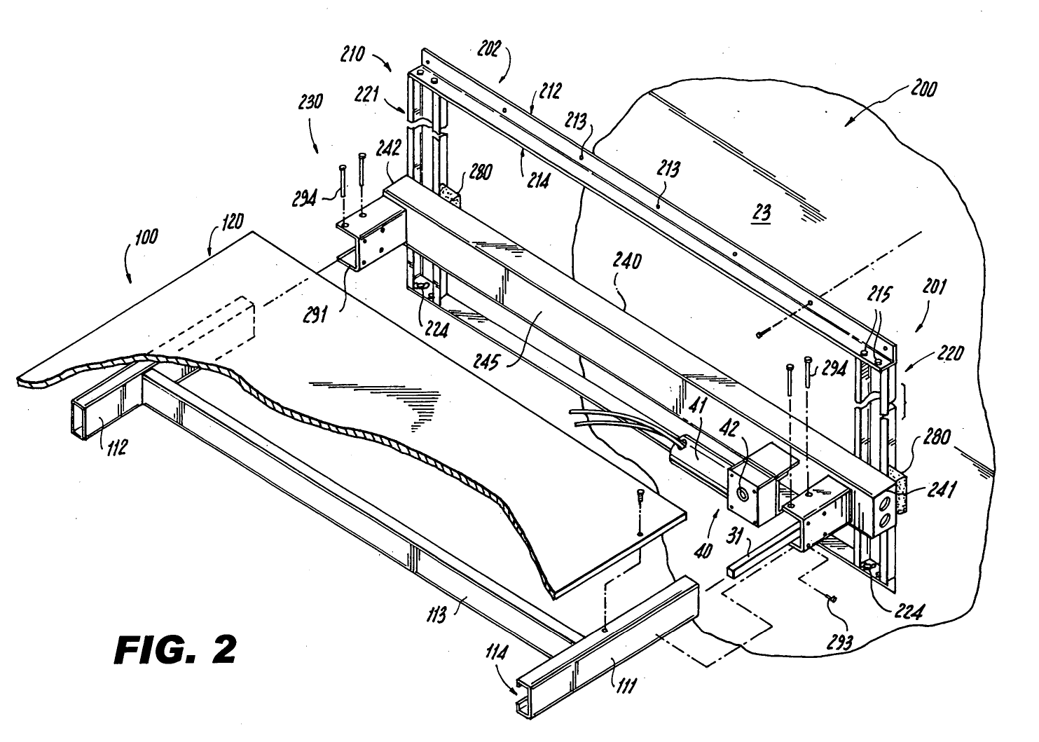

FIG. 2 is an exploded perspective view of the power side assembly 200 of the chain-driven bed lift mechanism 30.

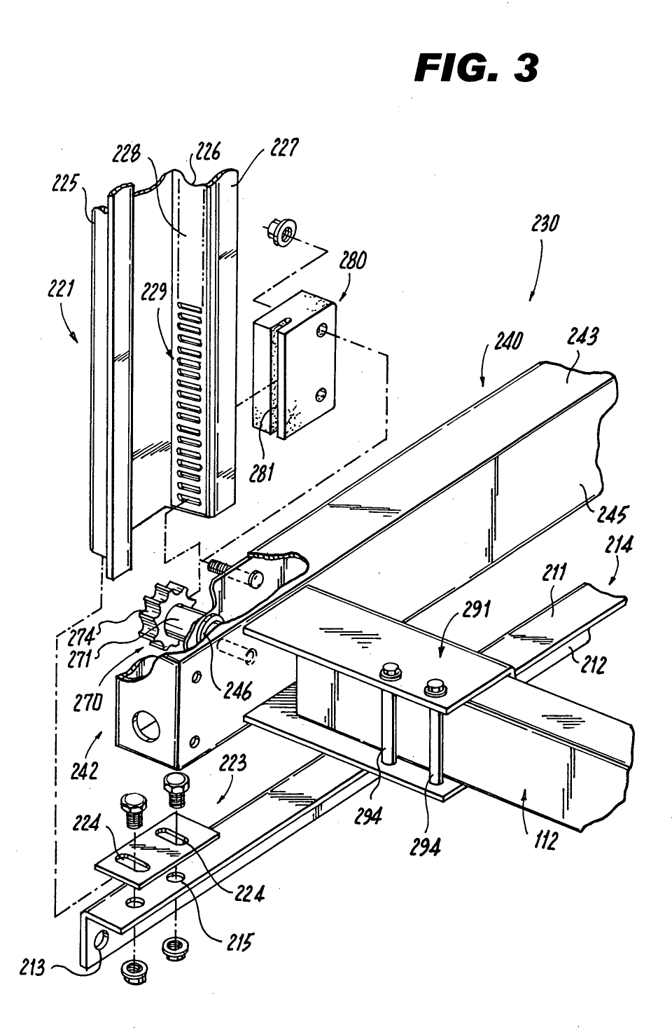

The power side assembly 200 has a first end 201 closer to the drive mechanism 40 and a second end 202. FIG. 3 is an exploded perspective view of the second end 202 of the power side assembly 200 of the chain-driven bed lift mechanism 30.

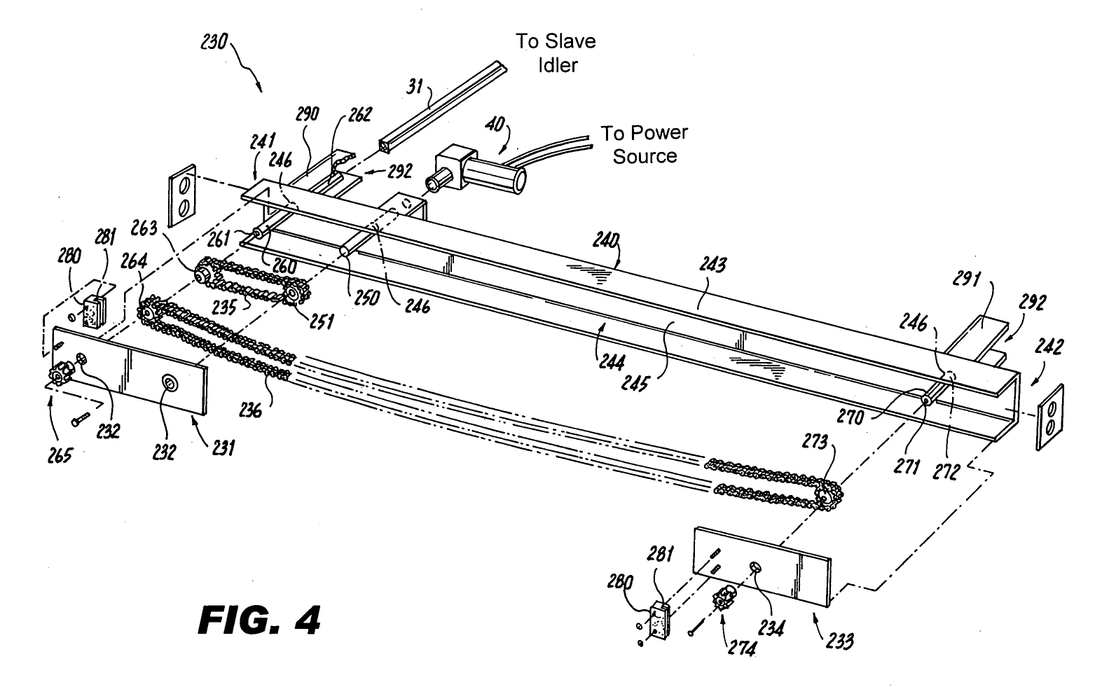

FIG. 4 is an exploded perspective view of a powerhead 230 of the power side assembly 200 of the chain-driven bed lift mechanism 30. The powerhead 230 is the portion of the power side assembly 200 that supports the bed 100. As the powerhead 230 moves up and down, the powerhead 230 lifts and lowers the bed 100.

The power side assembly 200 also includes a frame 210. The frame 210 is mounted to the side wall 23 of the toy trailer 10 closest to the power side assembly 200 and remains stationary with respect to the bed 100 as the bed 100 is raised and lowered.

The frame 210 of the power side assembly 200 includes two horizontal angle brackets 211 for mounting the power side assembly 200 to the side walls 23 of the toy trailer 10 and first and second vertical track members 220, 221 for guiding the powerhead 230. Each of the angle brackets 211 includes a vertical portion 212 and a horizontal portion 214, which are preferably perpendicular to each other (thus, L-shaped bracket). The vertical portions 212 of the angle brackets 211 are positioned flush against the side walls 23, and mounting holes 213 are provided on the vertical portions 212 of the angle brackets 211 for fastening, e.g., using screws, the angle brackets 211 to the side walls 23.

The horizontal portions 214 of the angle brackets 211 extend away from the side wall 23 of the toy trailer 10. Mounting holes 215 are provided on the horizontal portions 214 for fastening each of the vertical track members 220, 221 at a top surface 222 and a bottom surface 223 to both of the angle brackets 211. Slots 224 are also provided at the top surface 222 and the bottom surface 223 of the vertical track members 220, 221 for fastening the vertical track members 220, 221 securely to the angle brackets 211. The slots 224 are perpendicular to the surface of the side walls 23 and allow the assembler of the bed lift mechanism 30 to align the vertical track members 220, 221 properly with respect to the angle brackets 211 so that the vertical track members 220, 221 are parallel to each other before fastening them to the angle brackets 211.

For example, if one side wall 23 is uneven or are not completely vertical, the slots 224 provide a way to adjust the positioning of the vertical track members 220, 221 to ensure that the vertical track members 220, 221 are parallel when they are mounted to the brackets 211. The side walls 23 of toy trailers 10 are sometimes thin enough to bow or deflect, which can cause one side wall 23 to have one or more bowed or dented sections compared to surrounding portions of the wall 23. This leads to an uneven mounting surface for receiving the vertical track members 220, 221 and also results in the side walls 23 no longer being parallel to each other. When the side walls 23 are no longer parallel, the distance between the side walls 23 at the ceiling 21 of the toy trailer 10 is different from the distance between the side walls 23 at the floor 22 of the toy trailer 10.

The illustrated vertical track members 220, 221 are formed in a question mark shape, i.e., having a U-shaped base 225 with a lip 227 connected to one arm 226 that forms a part of the U-shaped base 225. The lip 227 extends away from the U-shaped base 225 and is perpendicular to the arm 226 onto which the lip 227 is connected.

A punch rack 228 with a plurality of successively-arranged slots 229 is disposed in each of the vertical track members 220, 221 and is disposed parallel and next to an inner surface of the arm 226 of the U-shaped base 225 on which the lip 227 is disposed. A space is formed between the punch racks 228 and the respective arms 226 so that a coupling gear 265, 274 (described below) can engage the slots 229 without interfering with the arm 226 on the opposite side of the punch racks 228. The U-shaped bases 225 of the vertical track members 220, 221 provide backings for the punch racks 228.

The powerhead 230 is mounted onto the frame 210 of the power side assembly 200 and includes a cross bar 240 that spans the width of the bed 100 between the two vertical track members 220, 221 of the frame 210. A first end 241 of the cross bar 240 is disposed near the first vertical track member 220, and a second end 242 of the cross bar 240 is disposed near the second vertical track member 221. The cross bar 240 has a U-shaped channel defined by a top arm 243 and a bottom arm 244 that are positioned parallel to each other, and the U-shaped channel opens toward the vertical track members 220, 221 of the frame 210 of the power side assembly 200. The cross bar 240 also has a vertical surface 245 joining the top arm 243 and the bottom arm 244. A first mounting plate 231 and a second mounting plate 232 are fastened to the first end 241 and the second end 242 of the cross bar 240, respectively. The first and the second mounting plates 231, 232 are disposed on the cross bar 240 to close a section of the opening of the U-shaped channel so that the cross bar 240 has a four-sided, rectangular shape at the first and the second mounting plates 231, 232.

The first mounting plate 231 in the powerhead 230 is provided with holes 232 for supporting a drive shaft 250 and a first lifting shaft 260. The drive shaft 250 and the first lifting shaft 260 are parallel to each other and are both perpendicular to the cross bar 240. The first lifting shaft 260 has a first end 261 and a second end 262 disposed inside the first vertical track member 221.

The second mounting plate 233 in the powerhead 230 is provided with a hole 234 for supporting a second lifting shaft 270. The second lifting shaft 270 is perpendicular to the cross bar 240 and is parallel to the drive shaft 250 and the first lifting shaft 260. The second lifting shaft 270 has a first end 271 and a second end 272 disposed inside the second vertical track member 221.

The vertical surface 245 of the cross bar 240 has three holes 246 for receiving and supporting the drive shaft 250, the first lifting shaft 260, and the second lifting shaft 270.

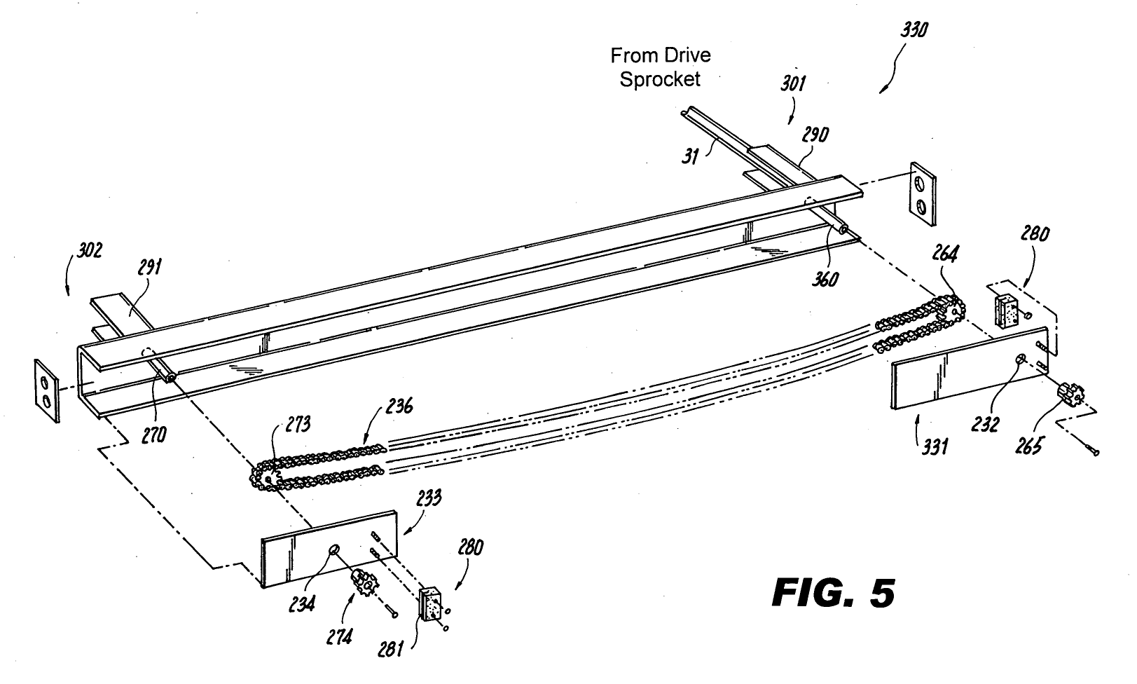

Glide blocks 280 are fastened near each end 241, 242 of the cross bar 240 on the vertical surface 245 on the side facing the frame 210 of the power side assembly 200. For example, the guide blocks 280 are fastened onto the first mounting plate 231, the second mounting plate 233, as shown in FIGS. 4 and 5. The guide block 280 has a slot 281 that is dimensioned to receive the lip 227 of the first or the second vertical track member 220, 221 so that the guide block 280 can slide up and down over the lip 227 as the powerhead 230 is driven up and down. The guide blocks 280 vertically guide the powerhead 230 as the powerhead 230 supports the bed 100 while the bed 100 is raised and lowered. The guide blocks 280 are preferably formed of UHMW (ultra high molecular weight) plastic or another type of material that can glide smoothly against the lip 227 of the vertical track member 220, 221.

Alternatively, the guide blocks 280 can be replaced by roller wheels (not shown) that roll against the opposite surface of the arm 226 from the punch racks 228, i.e., the outer surface of the arm 226 with respect to the U-shaped base 225 of the vertical track member 220, 221. The roller wheels can be fastened onto the first mounting plate 231 and the second mounting plate 233. The roller wheels vertically guide the powerhead 230 as the powerhead 230 supports the bed 100 as it is raised and lowered. The roller wheel reduces drag friction against the U-shaped base 225 of the vertical track member 220, 221.

The drive mechanism 40, which is included in the powerhead 230, is mounted to the side of the vertical surface 245 of the cross bar 240 facing the bed 100 and close to the first end 201 of the power side assembly 200. The drive shaft 250 extends from the drive mechanism 40 and is supported by the hole 246 in the vertical surface 245 of the cross bar 240. The drive mechanism 40 transfers rotational motion to the drive shaft 250.

A first drive sprocket 251 is disposed on the drive shaft 250 and is positioned inside the cross bar 240, between the vertical surface 245 of the cross bar 240 and the first mounting plate 231. The first drive sprocket 251 is rotatably fixed with respect to the drive shaft 250 and thus the two rotate together.

The drive shaft 250 transfers rotational motion from the drive mechanism 40 to the associated first lifting shaft 260 via the short chain 235 in the powerhead 230. The short chain 235 encircles the first drive sprocket 251 on the drive shaft 250 and a second drive sprocket 263, which is rotatably fixed on the first lifting shaft 260. The first lifting shaft 260 is supported by the hole 246 in the cross bar 240 and by the hole 232 in the first mounting plate 231.

A third drive sprocket 264 and a first coupling gear 265 are also rotatably fixed on the first lifting shaft 260. The rotational motion from the drive shaft 250 is transferred to the first lifting shaft 260 via the short chain 235 that is wound around the first drive sprocket 251 and the second drive sprocket 263. The rotational motion of the drive shaft 250 is then transferred to the third drive sprocket 264 and the first coupling gear 265, which are disposed on the first lifting shaft 260. The second and the third drive sprockets 263, 264 are positioned inside the cross bar 240, between the vertical surface 245 of the cross bar 240 and the first mounting plate 231.

The first coupling gear 265 is positioned on the second end 262 of the first lifting shaft 260 outside the cross bar 240 and inside the first vertical track member 220 of the frame 210 of the power side assembly 200. The first coupling gear 265 engages with the slots 229 in the punch rack 228 in the first vertical track member 220 to raise or lower the powerhead 230.

A fourth drive sprocket 273 is rotatably fixed on the second lifting shaft 270. The long chain 236 in the powerhead 230 is entrained over the third drive sprocket 264 on the first lifting shaft 260 and the fourth drive sprocket 273 on the second lifting shaft 170. The second lifting shaft 270 is supported within the hole 246 in the cross bar 240 and within the hole 244 in the second mounting plate 233.

A second coupling gear 274 is also rotatably fixed on the second lifting shaft 270. The rotational motion from the first lifting shaft 260 is transferred to the second lifting shaft 270 via the long chain 236. The fourth drive sprocket 273 is housed inside the cross bar 240, between the vertical surface 245 of the cross bar 240 and the second mounting plate 233.

The second coupling gear 274 is positioned on the second end 272 of the second lifting shaft 270 outside the cross bar 240 and inside the second vertical track member 221 of the frame 210 of the power side assembly 200. The second coupling gear 274 engages with the slots 229 in the punch rack 228 in the second vertical track member 221 to help raise or lower the powerhead 230.

Thus, the driving engagement of the first and the second coupling gears 265, 274 serves to lift or lower the powerhead 230, thereby lifting or lowering the bed 100. Since the guide blocks 280 slide along the lip 227 of the vertical track members 220, 221 as the powerhead 230 moves up and down, the guide blocks 280 act as backers for the punch racks 228 as the coupling gears 265, 274 engage with the slots 229, thereby preventing deflection of the vertical track members 220, 221 and the punch racks 228 as the powerhead 230 moves up and down.

The guide blocks 280 also prevent access to the punch racks 228 while the bed lift mechanism 30 is operating. This safety feature prevents kids from reaching into the vertical track members 220, 221, thereby risking the loss of fingers which could be caught between the first or the second coupling gear 265, 274 and the respective punch rack 228. The guide blocks 280 also eliminate pinch points between the vertical track members 220, 221 and the cross bar 240.

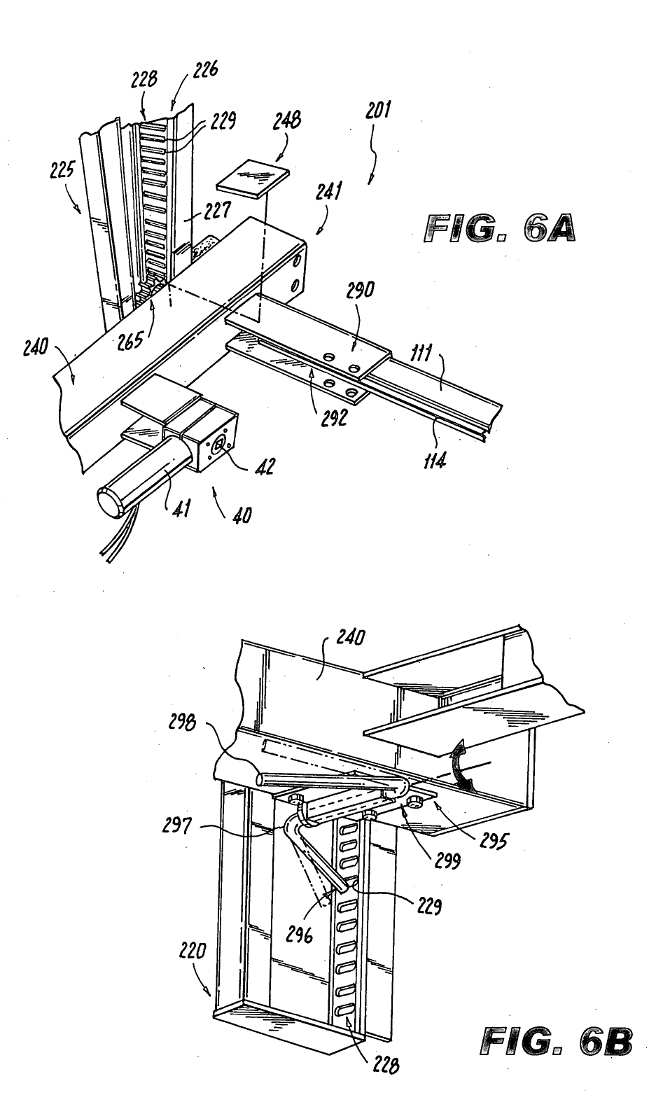

Gear covers 248 (shown in FIG. 6A) can be mounted onto the top arm 243 of the cross bar 240 to extend into the first vertical track member 220 and the second vertical track member 221. The gear covers 248 are provided to prevent exposure of the first coupling gear 265 and the second coupling gear 274 as they are driven along the first vertical track member 220 and the second vertical track member 221. The gear covers 248 prevent objects from interfering with the first and the second coupling gears 265, 274 as they engage with gear racks 228 in the first and the second vertical track members 220, 221.

A hole (not shown) is provided at the first end 261 of the first lifting shaft 260. The telescoping shaft 31 is fastened to the hole using a fastener such as a bolt and hex nut. The telescoping shaft 31 can be extended to connect the first lifting shaft 260 of the power side assembly 200 to a first lifting shaft 360 of the slave side assembly 300. The first lifting shaft 360 of the slave side assembly 300 is identical to the first lifting shaft 260 in the power side assembly 200 except that the first lifting shaft 360 of the slave side assembly 300 is not connected directly to a drive mechanism, since the slave side assembly 300 does not include a separate drive mechanism.

The telescoping shaft 31 is shown as a square shaft in FIGS. 2 and 4; however, it is understood that the telescoping shaft 31 can be formed having a cross section with a different shape as long as it can be extended or retracted to connect the power side assembly 200 to the slave side assembly 300. The length of the telescoping shaft 31 can be adjusted so that bed frames of varying length can be included in the bed lift mechanism 30.

A first mounting channel 290 and a second mounting channel 291 are included in the powerhead 230. The mounting channels 290, 291 are U-shaped channels that are large enough to receive the rails 111, 112 of the bed frame 110. The two rails 111, 112 of the bed frame 110 are received in the mounting channels 290, 291 so that the bed 100 can be raised and lowered with the powerhead 230.

The mounting channels 290, 291 are mounted onto the cross bar 240 so that the first mounting channel 290 houses the telescoping shaft 31 and the first end 261 of the first lifting shaft 260. The second mounting channel 291 houses the first end 271 of the second lifting shaft 270.

The U-shaped channels of the mounting channels 290, 291 are oriented in the same configuration with respect to the powerhead 230 so that the openings of the U-shaped channels open toward the same direction. Clamping bolts 293 are provided for fastening the rails 111, 112 of the bed frame 110 to the mounting channels 290, 291.

Retaining rods 294 are disposed crosswise over the opening 292 of each of the U-shaped mounting channels 290, 291. The retaining rods 294 prevent misalignment of the bed frame 110 prior to installing the clamping bolts 293. The retaining rods 294 hold the rails 111, 112 of the bed frame 110 as the rails 111, 112 slide into the mounting channels 290, 291.

The drive side rail 111 includes an opening 114 on an inner side toward the cross bars 113 of the bed frame 110. The opening 114 in the drive side rail 111 faces the opposite rail 112 and allows the insertion of the telescoping shaft 31 when the bed frame 110 is installed onto the power side assembly 200 and the slave side assembly 300, as described below. Thus, the telescoping shaft 31 is enclosed within the drive side rail 111 of the bed frame 110, thereby providing a safe design in which fingers or other objects cannot be caught by the rotation of the telescoping shaft 31.

Since the rotating telescoping shaft 31 is enclosed within the drive side rail 111, the space between the side rails 111, 112 and the cross bars 113 of the bed frame 110 can be used for storage, e.g., tools or bedding, as described below.

The slave side assembly 300 has a first end 301, which is opposite to the first end 201 of the power side assembly 200, and a second end 302, which is opposite to the second end 202 of the power side assembly 200.

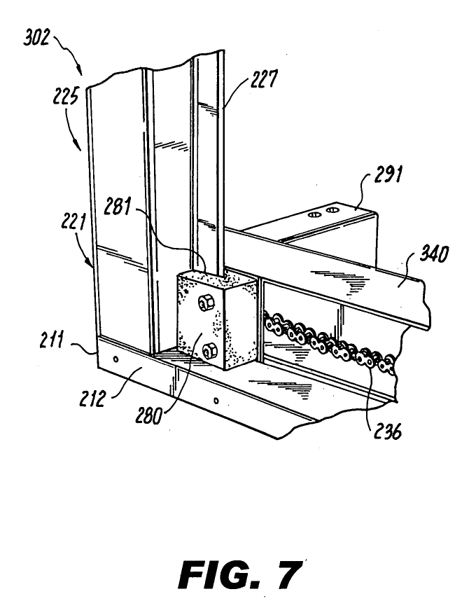

FIG. 5 is an exploded perspective view of the powerhead 330 of the slave side assembly 300 of the chain-driven bed lift mechanism 30. FIG. 7 is a perspective view of the second end 302 of the slave side assembly 300 of the chain-driven bed lift mechanism 30. The components of the slave side assembly 300 shown in FIGS. 3, 5, and 7 that are identical to the parts of the power side assembly 200 are denoted by identical reference characters and will not be described in detail.

As described above, the difference between the slave side assembly 300 and the power side assembly 200 is that the power side assembly 200 includes the drive mechanism 40, such as a crank or a motor, in the powerhead 230. The slave side assembly 300 does not include the drive shaft 250, the first drive sprocket 251, the short chain 235, and the second drive sprocket 263. The first lifting shaft 360 in the slave side assembly 300 is supported by the hole 246 in the cross bar 340 and the first mounting plate 331, and the third drive sprocket 264 and the first coupling gear 265 are non-rotatably disposed on the first lifting shaft 360. Furthermore, the first mounting plate 331 in the slave side assembly 300 includes the hole 232 for supporting the first lifting shaft 360.

The cross bar 340 in the slave side assembly 300 includes holes 246 to support the first lifting shaft 360 and the second lifting shaft 270. The long chain 236 in the slave side assembly 300 is wound around the third drive sprocket 264 and the first lifting shaft 360 and the fourth drive sprocket 273 on the second lifting shaft 270.

FIG. 6A is a sectional view of the first end 201 of the power side assembly 200 of the chain-driven bed lift mechanism 30, and FIG. 6B is a sectional perspective view of a bottom side of the first end of the power side assembly shown in FIG. 6A. More particularly, FIG. 6B shows a locking system including a locking lever 295 mounted to the underside of the cross bar 240.

The locking lever 295 has a first end 296, a middle portion 297, and a second end 298. A plate 299 supports the middle portion 297, which is rotatably attached to the underside of the cross bar 240 to fix the locking lever 295 in position on the cross bar 240. A longitudinal axis of the middle portion 297 is oriented perpendicular to the longitudinal direction of the cross bar 240 and allows the locking lever 295 to rotate with respect to the longitudinal axis of the middle portion 297.

The first end 296 of the locking lever 295 is oriented at an angle from the middle portion 297 so that it can be engaged or disengaged with the slots 229 of the gear rack 228 in the first vertical channel 220. The second end 298 of the locking lever 295 is oriented at the opposite end of the middle portion 297 at an angle so that it can be gripped by the operator of the bed lift mechanism 30 in order to rotate the locking lever 295. The rotation of the second end 298 causes the engagement or disengagement, depending on the direction of rotation, of the first end 296 of the locking lever 295 in the slot 229 of the gear rack 228.

If the operator rotates the second end 298 of the locking lever 295 so that the second end 298 is aligned generally flush with the underside of the cross bar 240, i.e., counterclockwise in FIG. 6B, then the first end 296 of the locking lever 295 is disengaged from the gear rack 228, as shown by the configuration in the dashed-dot line. While the lever 295 is disengaged from the gear rack 228, the operator can activate the drive mechanism 40 to raise or lower the bed 100.

If the operator rotates the second end 298 of the locking lever 295 so that the second end 298 is positioned at an angle from the underside of the cross bar 240, i.e., clockwise in FIG. 6B, then the first end 296 of the locking lever 295 is engaged with the gear rack 228, as shown by the configuration in the solid line. Thus, the operator is prevented from operating the drive mechanism 40 to lower the bed 100, since the first end 296 rests against the gear rack 228. When the first end 296 engages with one of the slots 229 in the gear rack 228, gravity and the weight of the bed lift mechanism 30 act to force the first end 296 of the locking lever 295 into the slot 229 in the gear rack 228.

The locking lever 295 prevents the bed 100 from lowering if the drive mechanism 40 or any other part of the bed lift mechanism 30, e.g., the drive sprockets 251, 263, 264, 273, were to fail to maintain the bed 100 at a raised elevation. The locking lever 295 acts as a safety precaution against unwanted downward movement of the bed 100.

Alternatively, the locking lever 295 can be automatically biased toward the locked or engaged position where the first end 296 of the locking lever 295 is engaged with the slot 229 in the gear rack 228. Thus, whenever the operator has let go of the second end 298 of the locking lever 295, the first end 296 tends to fall into the next available slot 229 in the gear rack 228.

The installation of the chain-driven bed lift mechanism 30 will now be described.

First, the power side assembly 200, without the telescoping shaft 31, is fastened onto one of the side walls 23 of the toy trailer 10. The power side assembly 200 is placed on top of a piece of plywood (not shown) or another type of support with a level edge. Fasteners are inserted through the mounting holes 213 in the vertical portion 212 of the top angle bracket 211 for mounting to the side wall 23. Then, the plywood is removed and fasteners are inserted through the mounting holes 213 in the vertical portion 212 of the bottom angle bracket 211 for mounting to the side wall 23. The same mounting process is completed for mounting the slave side assembly 300 to the opposite side wall 23. Thus, the power side assembly 200 and the slave side assembly 300 are installed in the toy trailer 10 before installing the bed frame 110.

The bed frame 110 is inserted sideways into the openings 292 in the mounting channels 290, 291. At this point, the telescoping shaft 31 has not been installed in the powerhead 230 of the power side assembly 200. With the bed frame 110 sitting in the mounting channels 290, 291, the retaining rods 294 are inserted into each of the mounting channels 290, 291.

With the power side assembly 200, the slave side assembly 300, and the bed frame 110 in place, the assembler of the bed lift mechanism 30 checks the vertical track members 220, 221 to ensure that all four of the vertical track members 220, 221 are parallel to each other. If the vertical track members 220, 221 are not parallel, they can be adjusted by loosening the fasteners connecting the top and bottom surfaces 222, 223 of the vertical track members 220, 221 to the angle brackets 211. The alignment of the vertical track members 220, 221 with respect to the angle brackets 211 can be adjusted by positioning the fastener within the slots 224 in the top and bottom surfaces 222, 223 of the vertical track members 220, 221, and then the fasteners can be tightened to secure the vertical track members 220, 221 in place.

Alternatively, the slots for adjusting the positioning of the vertical track members 220, 221 can be provided in the horizontal portions 214 of the angle brackets 211 and holes can be provided in the top and bottom surfaces 222, 223 of the vertical track members 220, 221.

When the power side assembly 200, the slave side assembly 300, and the bed frame 110 are positioned so that the vertical track members 220, 221 are aligned properly, the clamping bolts 293 are inserted into the mounting channels 290, 291 and the rails 111, 112 of the bed frame 110 to secure the bed frame 110 in place.

Then, the telescoping shaft 31 is inserted through the opening 114 in the drive side rail 111 of the bed frame 110. The telescoping shaft 31 is fastened to one of the first ends 261, 361 of the first lifting shafts 260, 360 of the power side assembly 200 or the slave side assembly 300. The length of the telescoping shaft 31 is adjusted so that mounting holes (not shown) on the telescoping shaft 31 are aligned with mounting holes (not shown) on the first ends 261, 361 of the first lifting shafts 260, 360 of the power side assembly 200 and the slave side assembly 300, and the telescoping shaft 31 is fastened onto the other one of the first ends 261, 361 of the first lifting shafts 260, 360 of the power side assembly 200 or the slave side assembly 300.

If a motor is provided, the motor is hooked up to a power source before operating the bed lift mechanism 30.

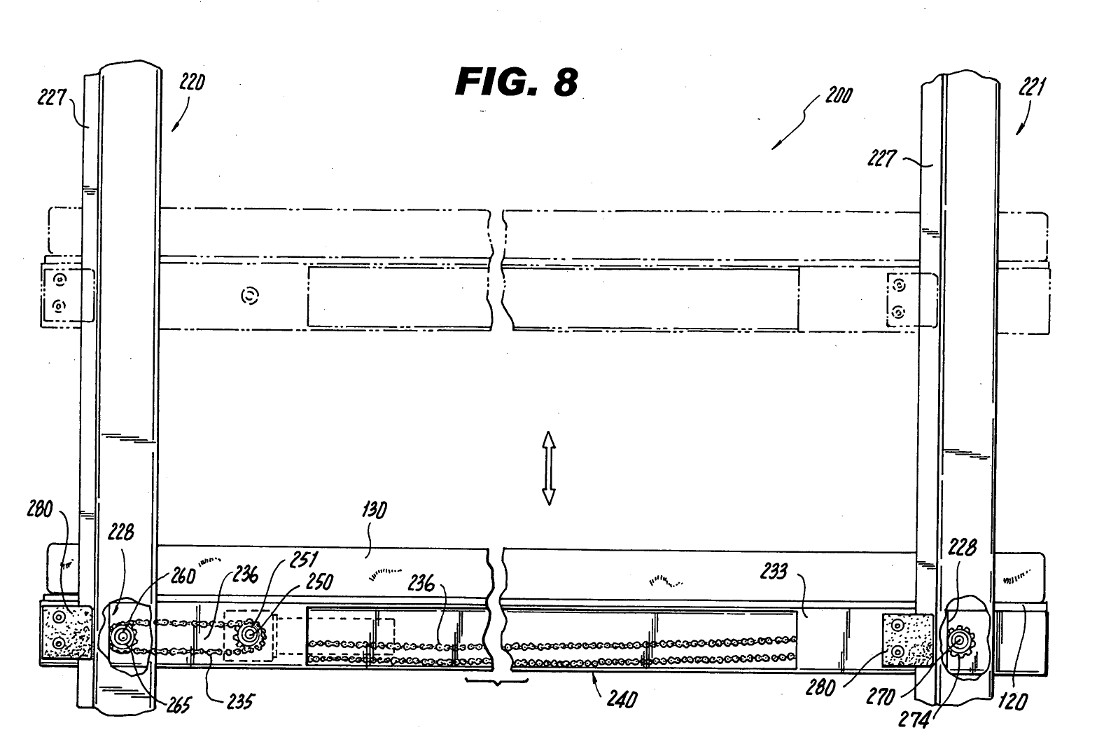

The operation of the lift mechanism 30 will now be described with the bed 100 starting in the raised position. FIG. 8 is a side view of the power side assembly 200 of the chain-driven bed lift mechanism 30 and illustrates the raised position (shown by the dashed-dot line) and the lowered position (shown by the solid line) of the powerhead 230 in the power side assembly 200.

When a user wants to lower the bed 100, the user activates the lift mechanism 30 by operating the drive mechanism 40, which is attached to the power side assembly 200. As the user activates the drive mechanism 40, the drive shaft 250 connected to the drive mechanism 40 rotates, thereby rotating the first drive sprocket 251 disposed on the drive shaft 250. The first drive sprocket 251 drivingly engages the short chain 235, which encircles the first drive sprocket 251 and the second drive sprocket 263. The rotational motion from the short chain 235 causes the second drive sprocket 263 to rotate, and since the second drive sprocket 263 is non-rotatably disposed on the first lifting shaft 260, the second drive sprocket 263 causes the first lifting shaft 260 to rotate. The rotation of the first lifting shaft 260 causes the third drive sprocket 264 and the first coupling gear 265 to rotate, since the third drive sprocket 264 and the first coupling gear 265 are also non-rotatably disposed on the first lifting shaft 260.

The third drive sprocket 264 drivingly engages the long chain 236, which encircles the fourth drive sprocket 273, which is disposed on the second lifting shaft 270 on the second end 242 of the cross bar 240. The rotational motion from the long chain 236 causes the fourth drive sprocket 273 to rotate, and since the fourth drive sprocket 273 is non-rotatably disposed on the second lifting shaft 270, the fourth drive sprocket 273 causes the second lifting shaft 270 to rotate. The rotation of the second lifting shaft 270 causes the second coupling gear 274 to rotate, since the second coupling gear 274 is non-rotatably disposed on the second lifting shaft 270.

The first and the second coupling gears 265, 274 are both driven by the rotational motion of the drive mechanism 40 as the drive shaft 250 is rotated by the drive mechanism 40. The first coupling gear 265 drivingly engages the slots 229 in the first vertical track member 220, and the second coupling gear 274 drivingly engages the slots 229 in the second vertical track member 221. As the first and the second coupling gears 265, 274 rotate, the powerhead 230 is driven downward, thereby lowering the bed frame 110.

Thus, the rotation of the drive shaft 250 in the power side assembly 200 causes the rotation of the first drive sprocket 251, the second drive sprocket 263, the third drive sprocket 264, the fourth drive sprocket 273, the first coupling gear 265, and the second coupling gear 274 at the same rate and at the same time.

The telescoping shaft 31 is connected to the first end 261 of the first lifting shaft 260 opposite the first coupling gear 265. The telescoping shaft 31 transfers the rotational motion from the drive shaft 250 via the first lifting shaft 260 of the power side assembly 200 to the first lifting shaft 360 of the slave side assembly 300. The telescoping shaft 31 is fastened to the first end 261 of the first lifting shaft 360 in the slave side assembly 300, which is closest to the power side assembly 200.

The rotational motion of the drive shaft 250 is transferred to the first lifting shaft 260 of the power side assembly 200 via the short chain 235, and the rotational motion of the first lifting shaft 260 of the power side assembly 200 is transferred to the first lifting shaft 360 of the slave side assembly 300 via the telescoping shaft 31.

The first and the second coupling gears 265, 274 in the slave side assembly 300 are both driven by the rotational motion of the drive mechanism 40 in the power side assembly 300 via the first lifting shaft 260 in the slave side assembly 300. The first coupling gear 265 drivingly engages the slots 229 in the first vertical track member 220 of the slave side assembly 300, and the second coupling gear 274 drivingly engages the slots 229 of the second vertical track member 221 in the slave side assembly 300. As the first and the second coupling gears 265, 274 rotate, the powerheads 230, 330 are driven downward, thereby lowering the bed frame 110.

After the bed 100 has been lowered to its preferred height, the user can activate the drive mechanism 40 to lift the bed 100 back to its original raised position. The operation of the bed lift mechanism 30 to raise the bed 100 is the same as for the lowering operation described above except that the drive shaft 250 is rotated in the opposite direction. As a result, the coupling gears 265, 274 rotate in the opposite direction, thereby causing the lift mechanism 30 to raise the bed 100.

All four coupling gears, i.e., the two first coupling gears 265 and the two second coupling gears 274 rotate in the same direction. Thus, the powerheads 230, 330 can be removed from the respective frames 210 without requiring the removal of the vertical track members 220, 221. The powerheads 230, 330 are removed from the frames 210 by disengaging the coupling gears 265, 274 from the slots 229 in the punch racks 228. Since the coupling gears 265, 274 rotate in the same direction, the punch racks 228 are located on the same side relative to the coupling gears 265, 274. The coupling gears 265, 274 are disengaged from the punch racks 228 by moving the powerheads 230, 330 so that each of the coupling gears 265, 274 moves away from the respective punch racks 228.

The advantages of the chain-driven belt lift mechanism 30 will now be described.

Since the drive shaft 250, the two first lifting shafts 260, the two second lifting shafts 270, and the telescoping shaft 31 are driven collectively by the single drive mechanism 40, there is no risk of binding in the lift mechanism 30. Since the coupling gears 265, 274 in the four vertical track members 220, 221 in the power side assembly 200 and in the slave side assembly 300 are synchronized, there is no danger that a corner of the bed frame 110 would move at a faster rate than another corner. Furthermore, there is no danger that two different corners of the bed frame 110 would start or stop moving at different times. The coupling gears at all of the corners of the bed frame 110 can be synchronized and driven at the same speed.

The coupling gears 265, 274 engage with the punch racks 228 in the vertical track members 220, 221 in a non-slip manner, thereby preventing misalignment of the bed 100. Furthermore, the coupling gears 265, 274 and punch racks 228 covered by the gear covers 248 and are housed within the vertical track members 220, 221, thereby preventing anything such as fingers or clothing from being caught between the coupling gears 265, 274 and the punch racks 228. The guide blocks 280 also ensure that there are no pinch points between the cross bars 240 and the vertical track members 220, 221.

Since a telescoping shaft 31 is provided for connecting the power side assembly 200 to the slave side assembly 300, the lift mechanism 30 can be adapted for use with bed frames of varying lengths. Simply by extending or retracting the length of the telescoping shaft 31, the lift mechanism 30 can be mounted to shorter or longer bed frames according to the user's preference.

The telescoping shaft 31 is enclosed within the drive side rail 111 of the bed frame 110, and the other rotating parts are enclosed within the cross bars 240 in the power side assembly 200 and the slave side assembly 300. Therefore, fingers or other objects cannot be caught by the rotation of the telescoping shaft 31, thereby providing a safe design. A storage space can be incorporated underneath the bed frame 110 since there are no exposed rotating parts, and there are fewer parts disposed underneath the bed frame 110.

A motor 41 can be provided in the drive mechanism 40 for powering the lift mechanism 30. Therefore, the lift mechanism 30 can be extended and retracted by pushing a button or by flipping a switch, for example. The motor 41 can be provided with a manual override 42 for connecting a hand crank like the hand crank described above. Furthermore, the motor can be replaced by a hand crank for manually powering the lift mechanism 30 without requiring a separate power source.

The bed lift mechanism 30 is easy to assemble and to install, and can be bought separately to install into the toy trailer 10. The bed frame 110 slides into the power side assembly 200 and the slave side assembly 300 after mounting the frames 210 of the power side assembly 200 and the slave side assembly 300 to the side walls 23 of the toy trailer 10.

The bed lift mechanism 30 can be disassembled easily. Since all four coupling gears 265, 274 rotate in the same direction, the powerhead 230 can be removed from the frames 210 without requiring the removal of the vertical track members 220, 221.

Furthermore, the vertical track members 220, 221 are positioned at each of the four corners of the bed frame 110, thereby ensuring a stable structure and allowing space for windows and window dressing therebetween.

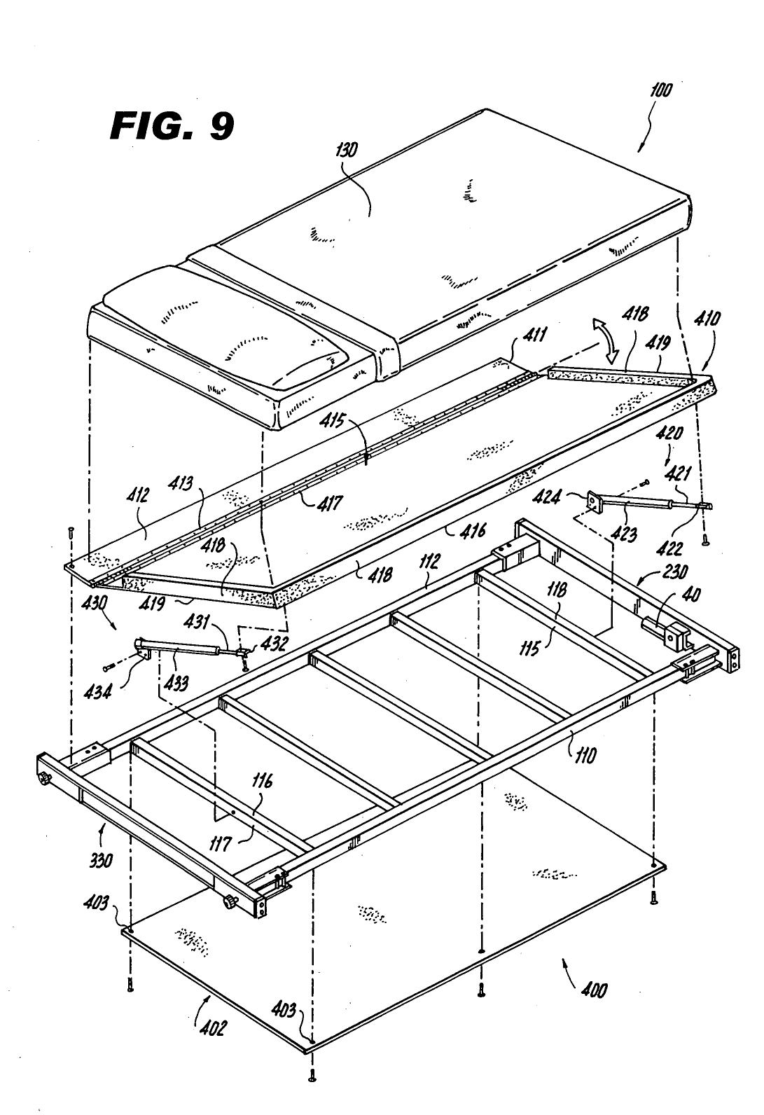

FIG. 9 is a perspective view of the toy trailer 10 with the chain-driven bed lift mechanism 30 and a storage compartment 400 incorporated below the bed 100.

The cross bar 113 of the bed frame 110 that is closest to the power side assembly 200 is a power side cross bar 115 and the cross bar 113 that is closest to the slave side assembly 300 is a slave side cross bar 116. A floor 402 of the storage compartment 400 is mounted via mounting holes 403 to the underside of the side rails 111, 112 of the bed frame 110 to enclose the space in the storage compartment 400 between the side rails 111, 112, the power side cross bar 115, and the slave side cross bar 116.

Thus, as described above, the space between the cross bars 113, 115 and the side rails 111, 112 of the bed frame 110 can be used for storage, e.g., tools or bedding. Since the rotating telescoping shaft 31 is enclosed within the drive side rail 111, the items placed in the storage compartment 400 will not interfere with the rotation of the telescoping shaft 31.

When the storage compartment 400 is included, a platform 120 is no longer provided on top of the bed frame 110. Instead, a panel 410 is disposed over the bed frame 110 for closing the storage compartment 400 and for supporting the mattress 130. The panel 410 includes a fixed portion 411 with mounting holes for mounting a first edge 412 of the fixed portion 411 to one of the side rails 111, 112; and a hinged portion 414 connected to the fixed portion 411 at a first edge 415 by a hinge 417 that is mounted to a second edge 413 of the fixed portion 411. The second edge 413 of the fixed portion 411 is opposite to the first edge 412 of the fixed portion 411.

As shown in FIG. 9, the fixed portion 411 is mounted to side rail 112; however, it is to be understood that the fixed portion 411 can alternatively be mounted to the drive side rail 111.

A second edge 416 of the hinged portion 414 is opposite to the first edge 415 of the hinged portion 414 that is connected to the hinge 417. The hinged portion 414 serves as a door for the storage compartment 400.

The hinged portion 414 also supports the mattress 130. Peripheral walls 418 are provided on the second edge 416 and on end edges 419 of the hinged portion 414 to prevent the mattress 130 from being displaced respective to the bed frame 110.

As shown in FIG. 9, the hinged portion 414 extends along the length of the bed frame 110 so that the end edges 419 of the hinged portion 414 overlap the cross bars 240, 340 in the power side assembly 200 and the slave side assembly 300; however, the hinged portion 414 can be shortened and the fixed portion 411 can be extended to provide a smaller door for the storage compartment 400.

Linear actuators, e.g., air cylinders 420, 430 having rods 421, 431 that are telescopically displaceable with respect to cylinders 421, 431, are disposed at opposite ends of the hinged portion 414 of the panel 410. Air cylinder 420 connects the power side cross bar 115 to the underside surface of the hinged portion 414 of the panel 410 at the end edge 419 closest to the power side assembly 200, and air cylinder 430 connects the slave side cross bar 116 to the underside surface of the hinged portion 414 of the panel 410 at the opposite end edge 419 closest to the slave side assembly 300.

Supports 422, 432 mounted to the respective rods 421, 431 are fastened to the respective portions of the underside surface of the hinged portion 414 of the panel 410. Alternatively, the supports 422, 432 can be mounted to respective surfaces of the peripheral walls 418 of the hinged portion 414 of the panel 410 that face the power side assembly 200 and the slave side assembly 300.

Support 424 mounted to cylinder 423 is fastened to a surface 117 of the power side cross bar 115 facing the power side assembly 200; and support 434 mounted to cylinder 433 is fastened to a surface 118 of the slave side cross bar 116 facing the slave side assembly 300.

The storage compartment 400 is limited to the space between the power side cross bar 115 and the slave side cross bar 116 in order to leave room for accommodating the air cylinders 420, 430. The air cylinders 420, 430 are placed outside the storage compartment 400 so that the items that are placed inside the storage compartment 400 do not interfere with the movement of the air cylinders 420, 430 and the hinged panel 414 is opened and closed.

The storage compartment 400 can be accessed by removing the mattress 130 and pulling the hinged portion 414 of the panel 410. The air cylinders 420, 430 control the movement of the hinged portion 414 of the panel 410 so that the hinged portion 414 is lifted smoothly. The hinged portion 414 can then be pulled back down to close the storage compartment 400, and the mattress 130 can be placed back onto the top surface of the hinged portion 414 of the panel 410.

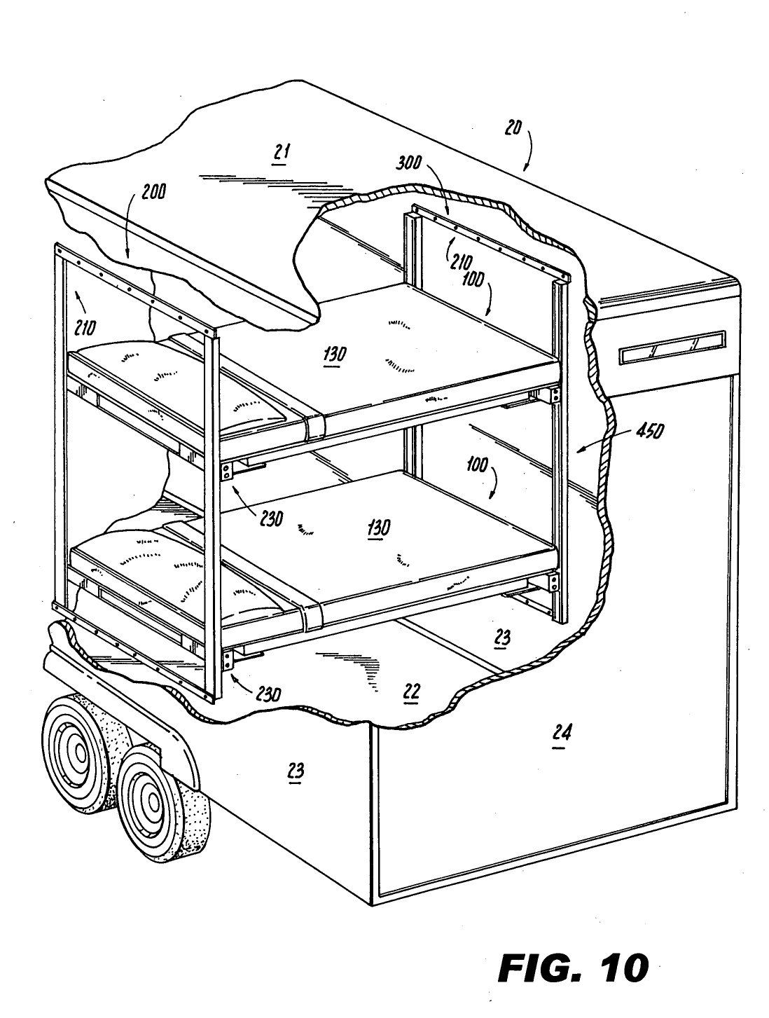

FIG. 10 is a perspective view of the toy trailer 10 with a chain-driven bed lift mechanism 450 according to another embodiment of the present invention. The components of the chain-driven bed lift mechanism 450 shown in FIG. 10 that are identical to the parts of the chain-driven bed lift mechanism 450 shown in FIGS. 1-9 will not be described in detail.

The chain-driven bed lift mechanism 450 has two beds 100, which are each raised and lowered via separate powerheads 230 that operate as described above. The two powerheads 230 are both coupled to the same frames 210.

The chain-driven bed lift mechanism 450 with two beds 100 is used for a bunk bed to deploy two separate beds 100 mounted to the same frames 210. This embodiment provides an additional bed and uses space efficiently since the beds 100 are mounted to powerheads 230 that are guided by the same frames 210.

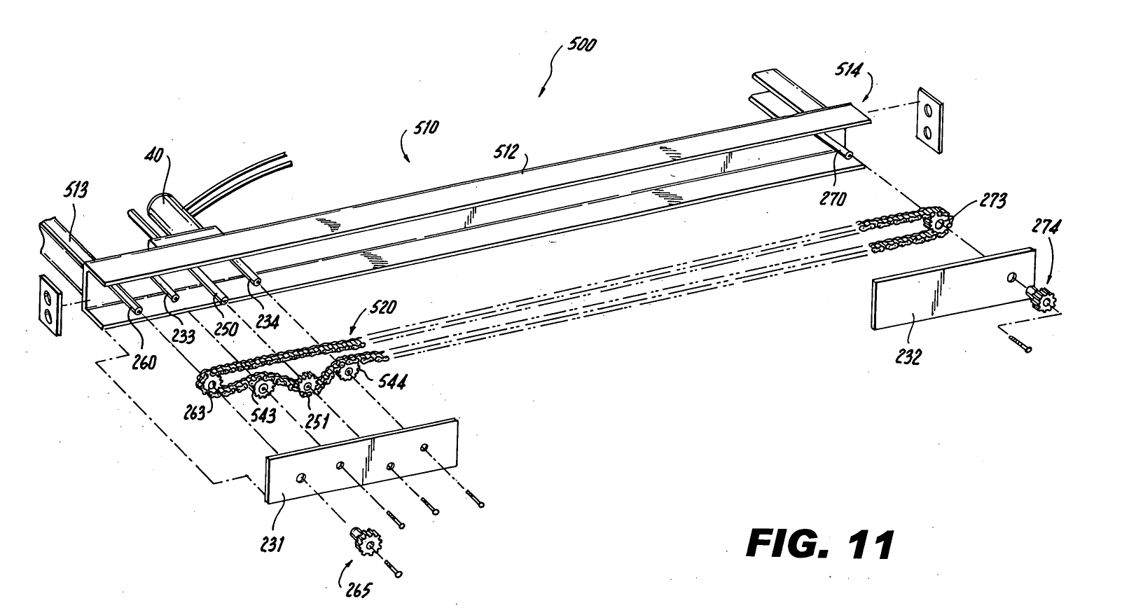

FIG. 11 is a side view of the toy trailer 10 with a chain-driven bed lift mechanism 500 having a powerhead 510, according to a further embodiment of the present invention. The chain-driven bed lift mechanism 500 is similar to the chain-driven bed lift mechanism 30 shown in FIGS. 1-9 except that the powerhead 510 is configured differently in the chain-driven bed lift mechanism 500 of FIG. 11 than the powerhead 230 of the chain-driven bed lift mechanism 30 of FIGS. 1-9. The frame of the power side assembly, the slave side assembly, and the drive mechanism are the same in both embodiments. The components of the embodiment shown in FIG. 11 that are identical to the components of the embodiment shown in FIGS. 1-9 are denoted by identical reference characters and will not be described in detail.

A single long chain 520 is used to raise and lower the bed. The short chain of the embodiment shown in FIGS. 1-9 is not included in the bed lift mechanism 500 shown in FIG. 11. A cross bar 512 with mounting plates 513, 514, which are similar to the cross bar 240, the mounting plates 231, 232 of the embodiment of FIGS. 1-9, spans the width of the bed between the two vertical track members of the frame.

A drive shaft 530 connected to the drive mechanism 40 mounted to the cross bar 512, the first lifting shaft 260, a third shaft 533, and a fourth shaft 534 are supported by holes in the first mounting plate 231 and the cross bar 512. The second lifting shaft 270 is supported by holes in the second mounting plate 232 and the cross bar 512. The drive shaft 530, the first lifting shaft 260, the third shaft 533, the fourth shaft 534, and the second lifting shaft 270 are disposed parallel to each other and perpendicular to the cross bar 512.

The third shaft 533 is disposed in the cross bar 512 between the drive shaft 530 and the first lifting shaft 260. The fourth shaft 534 is disposed in the cross bar 512 between the drive shaft 530 and the second lifting shaft 270 and closer to the drive shaft 530.

The third drive sprocket from the embodiment of FIGS. 1-9 is removed from the first lifting shaft 260, since there is no longer a small chain.

The fourth drive sprocket 273 disposed on the second lifting shaft 270 is aligned with the first drive sprocket 251 disposed on the drive shaft 530 and the second drive sprocket 263 disposed on the first lifting shaft 260. A fifth drive sprocket 543 and a sixth drive sprocket 544 are aligned with the first drive sprocket 251, the second drive sprocket 263, and the fourth drive sprocket 273.

The fifth drive sprocket 543 is non-rotatably disposed on the third shaft 533 between the first mounting plate 231 and the cross bar 512. The fifth drive sprocket 543 is therefore located between the first drive sprocket 251 on the drive shaft 250 and the second drive sprocket 263 on the first lifting shaft 260.

The sixth drive sprocket 544 is non-rotatably disposed on the fourth shaft 534 between the first mounting plate 231 and the cross bar 512. The sixth drive sprocket 544 is therefore located near the first drive sprocket 251 between the first drive sprocket 251 and the fourth drive sprocket 273.

The long chain 520 is wound in part in a generally serpentine path to encircle the second drive sprocket 263, the fifth drive sprocket 243, the first drive sprocket 251, the sixth drive sprocket 544, and the third drive sprocket 273. In the counter-clockwise direction facing the cross bar 512 and the bed, as shown in FIG. 11, the long chain 520 wraps around the left side of the second drive sprocket 263, under the second drive sprocket 263, under the fifth drive sprocket 543, over the first drive sprocket 251, and then over the sixth drive sprocket 544. After wrapping over the sixth drive sprocket 544, the long chain 520 wraps under and around the right side of the fourth drive sprocket 273. Since the second drive sprocket 263 and the fourth drive sprocket 273 are disposed at a higher elevation on the crossbar 512 than the fifth drive sprocket 543, the first drive sprocket 251, and the sixth drive sprocket 544, the long chain 520 passes over without contacting the sixth drive sprocket 544, the first drive sprocket 251, and the fifth drive sprocket 543 before contacting the top of the second drive sprocket 263.

The serpentine path allows the long chain 520 to maintain sufficient contact between the drive sprockets 263, 543, 251, 544, 273, thereby allowing for an efficient transfer of torque from the drive mechanism 40 located near a first end 513 of the cross bar 512 to the fourth drive sprocket 273 located near the second end 514 of the cross bar 512.

The slave side assembly and the operation of the bed lift mechanism 500 to raise and lower the bed are the same as in the embodiment shown in FIGS. 1-9 with the long chain 520 being used to transfer the rotational motion from the drive mechanism 40 mounted to the powerhead 510 to the first lifting shaft 260 and the second lifting shaft 270 at the first and the second ends 513, 514 of the cross bar 512.

Belt-Driven Bed Lift Mechanism

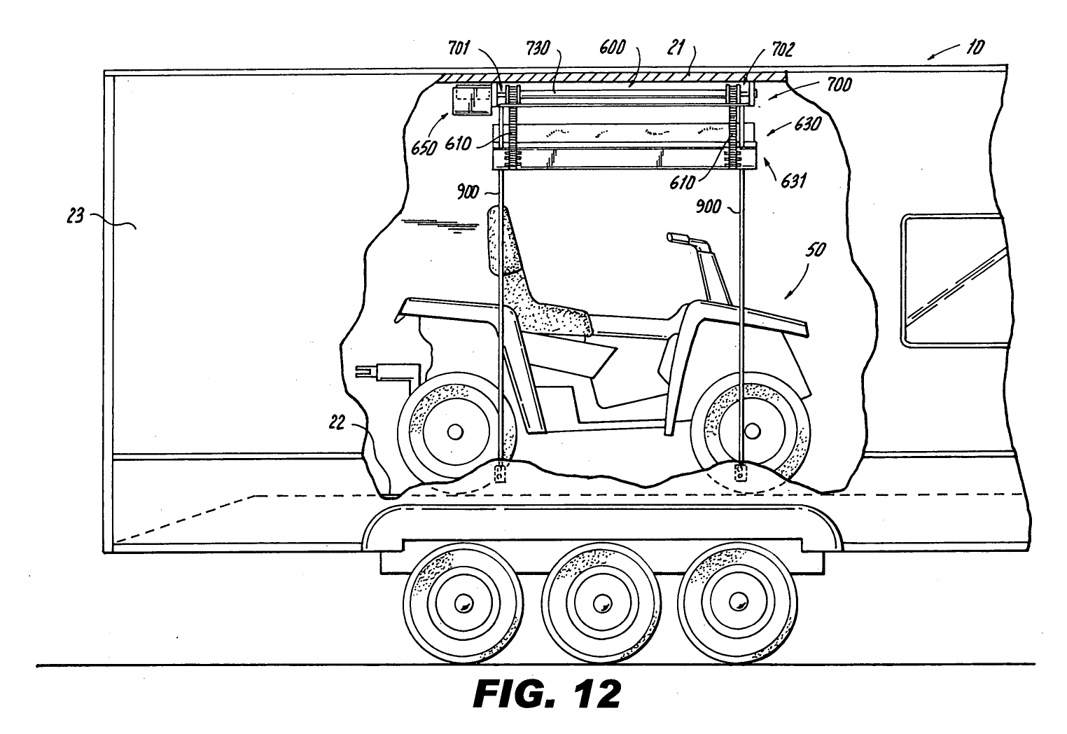

FIGS. 12-22 illustrate an embodiment of a belt-driven bed lift mechanism 600 according to the present invention. FIG. 12 is a side view of the belt-driven bed lift mechanism 600 in the rear section 20 of the toy trailer 10. An ATV 50 is stored underneath a bed 630, which is in the raised position.

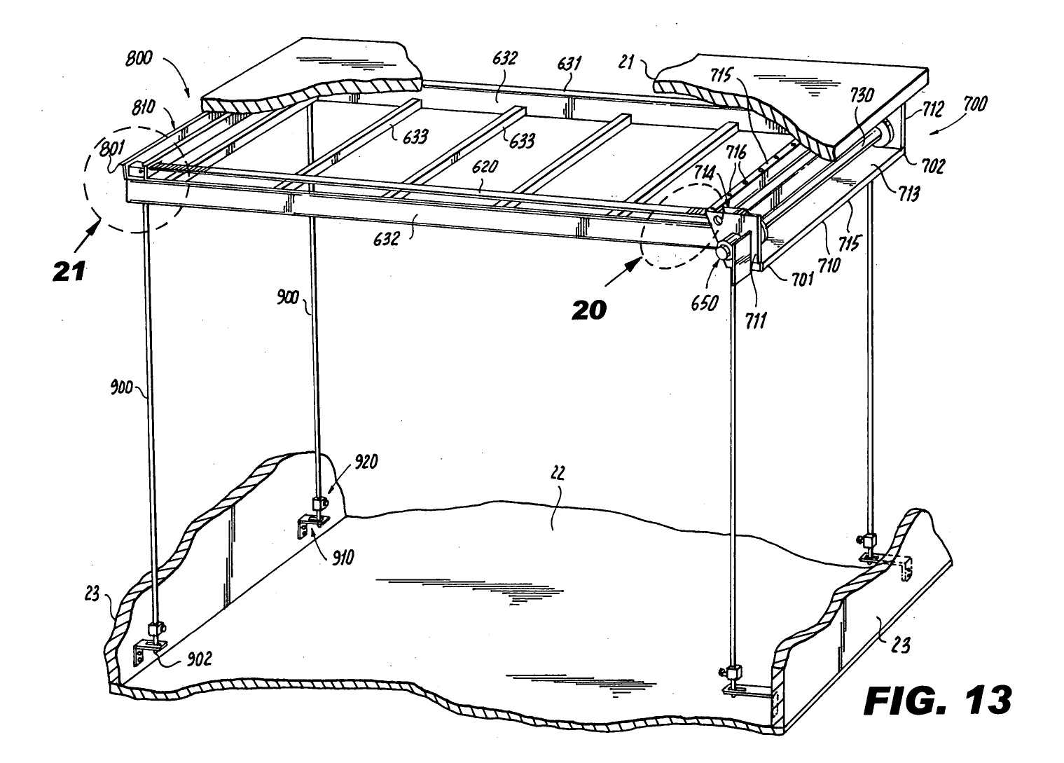

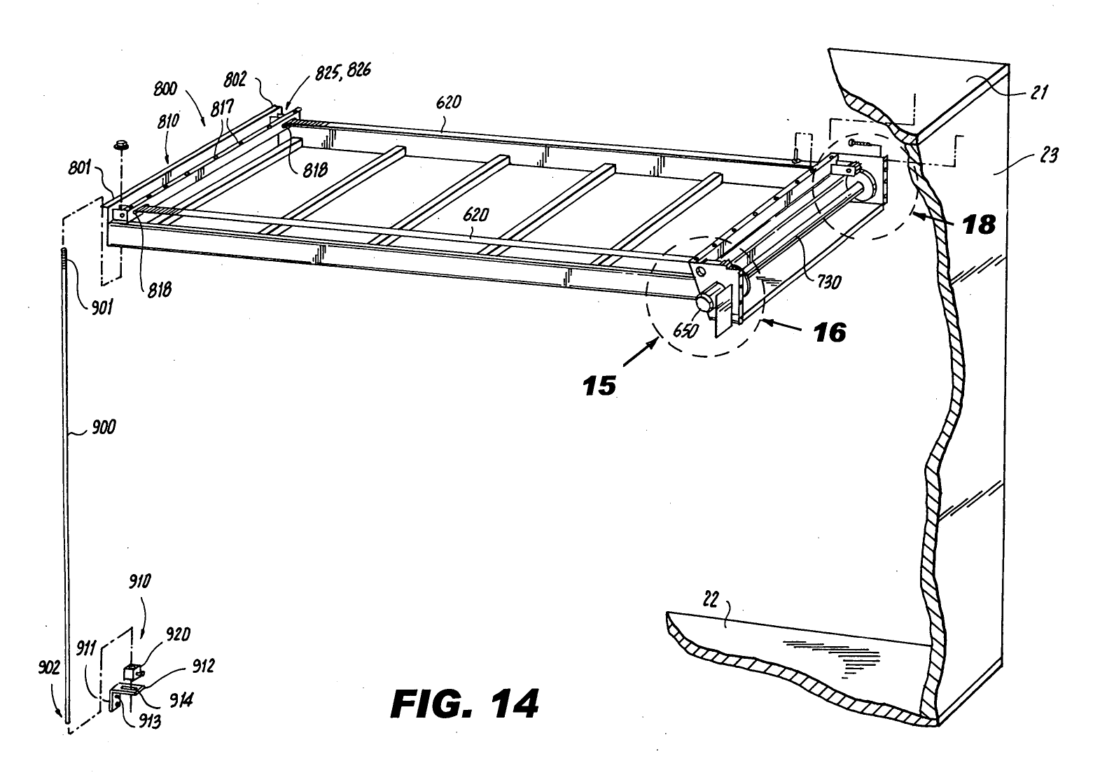

FIG. 13 is a perspective view of the belt-driven bed lift mechanism 600, which is driven to raise and lower the bed 630 in the toy trailer 10, and FIG. 14 is an exploded perspective view of the belt-driven bed lift mechanism 600.

The lift mechanism 600 includes a power side assembly 700 and a slave side assembly 800. The power and slave side assemblies 700, 800 are mounted to opposite side walls 23 of the rear section 20 of the toy trailer 10.

The bed 630 includes a bed frame 631, which includes two rails 632 that span the distance between the power side assembly 700 and the slave side assembly 800 and cross bars 633 that connect the two rails 632 at regular intervals therebetween.

At each of the corners of the bed frame 632, a plate 634 (FIG. 19) is mounted parallel to the side walls 23 of the toy trailer 10. Multiple horizontal slots 635, e.g., three slots, are provided in each of the plates 634, and a first belt 610 or a second belt 620, depending on the corner of the bed frame 631 to which the plate 634 is mounted, is threaded through the slots 635 to secure the belts 610, 620 to the bed frame 631.

The pair of first belts 610 is used to raise and lower the two corners of the bed frame 631 closer to the power side assembly 700. The pair of second belts 620 is used to raise and lower the two corners of the bed frame 631 closer to the slave side assembly 800.

As described above in relation to the chain-driven bed lift mechanism 30, the difference between the power side assembly 700 and the slave side assembly 800 is that the power side assembly is connected directly to a drive mechanism 650, such as a crank or a motor. The slave side assembly 800 is not connected directly to the drive mechanism 650 and is driven by the power side assembly 700. The power side assembly 700 is connected to the slave side assembly 800 by the belts 610, 620, which extend from the power side assembly 700.

The power side assembly 700 has a first end 701 and a second end 702. The power side assembly 700 includes an L-shaped corner bracket 710 with a first end plate 711 disposed near the first end 701 of the power side assembly 700 and a second end plate 712 disposed near the second end 702 of the power side assembly 700. The corner bracket 710 forms an enclosed space between the adjoining side wall 23 and the ceiling 21 of the toy trailer 10.

A horizontal surface 713 and a vertical surface 714 of the corner bracket 710 extend between the first end plate 711 and the second end plate 712 and together form the L-shape of the corner bracket 710. The horizontal surface 713 of the corner bracket 710 is parallel to the ceiling 21 of the toy trailer 10, and the vertical surface 714 of the corner bracket 710 is parallel to the side walls 23 of the toy trailer 10.

The horizontal surface 713 and the vertical surface 714 of the corner bracket 710 are provided with flanges 715 that are positioned flush against the side wall 23 and the ceiling 21 of the toy trailer 10. Mounting holes 716 are formed on the flanges 715 of the corner bracket 710 for mounting the corner bracket 710 to the side wall 23 and the ceiling 21.

The length of the corner bracket 710, i.e., of the vertical surface 713 and the horizontal surface 714, is approximately equal to the width of the bed 630 between the two rails 632 of the bed frame 631. Thus, the first end plate 711 and the second end plate 712 of the corner bracket 710 are generally disposed near two corners of the bed frame 632.

A step 720 is formed inside the corner bracket 710 and extends between the first end plate 711 and the second end plate 712 of the corner bracket 710. The step 720 has a horizontal surface 721 that is raised from the horizontal surface 713 of the corner bracket 710 and a vertical surface 722 disposed closer to the side wall 23 than the vertical surface 714 of the corner bracket 710. In the raised position, one side of the bed frame 631 is received within the underside of the step 620. Thus, the vertical surface 714 of the corner bracket 710 is disposed above the step 720 and closer to the ceiling 21 of the toy trailer 10.

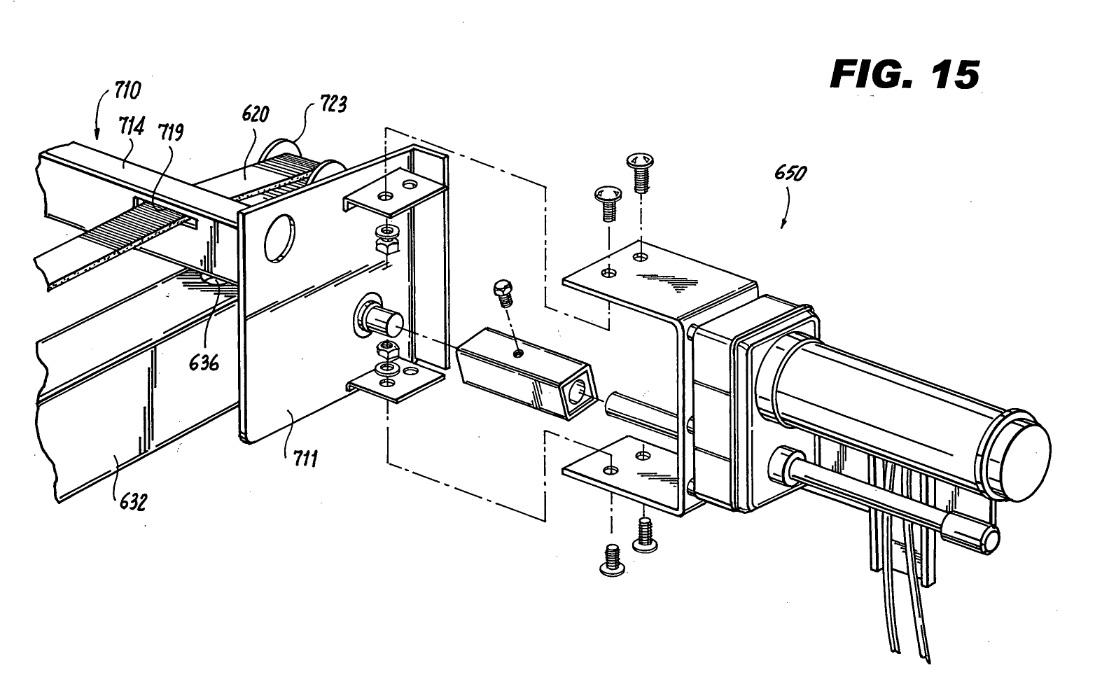

FIG. 15 is an exploded sectional perspective view taken in section 14 of FIG. 14 of the drive mechanism 650 mounted to the first end 701 of the power side assembly 700 of the belt-driven bed lift mechanism 600. The drive mechanism 650 is mounted onto the first end plate 711 and is disposed outside of the corner bracket 710; however, it is understood that the drive mechanism 650 can be mounted onto the second end plate 712 of the corner bracket 710.

The drive mechanism 650 is mounted to the corner bracket 710, which is mounted to the side wall 23 and the ceiling 21 of the toy trailer 10. Unlike the drive mechanism 40 of the chain-driven bed lift mechanism 30, the drive mechanism 650 of the belt-driven lift mechanism 600 remains stationary on the corner bracket 710 and does not move up and down with the power side assembly 700. In the chain-driven lift mechanism 30, the drive mechanism 40 is mounted to the powerhead 230, which moves up and down with the bed 100.

A drive shaft 730 extends from the drive mechanism 650 into the corner bracket 710. The drive shaft 730 is supported by bearings in holes 717 in the first end plate 711 and the second end plate 712 of the corner bracket 710.

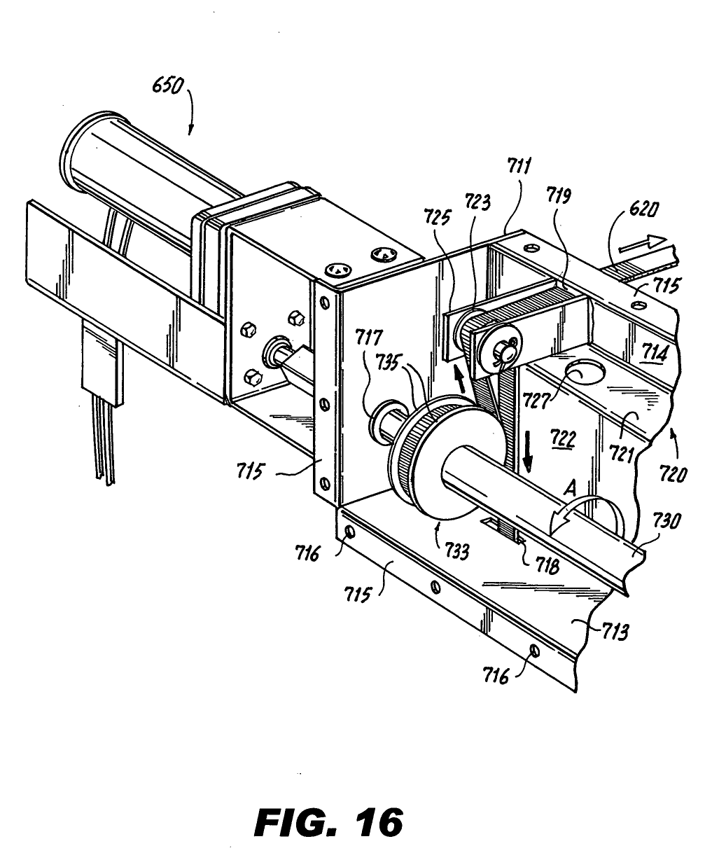

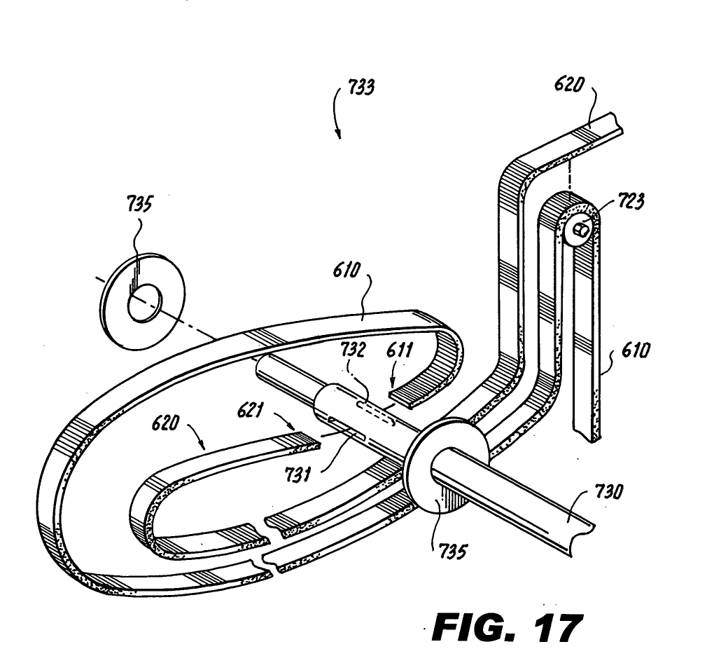

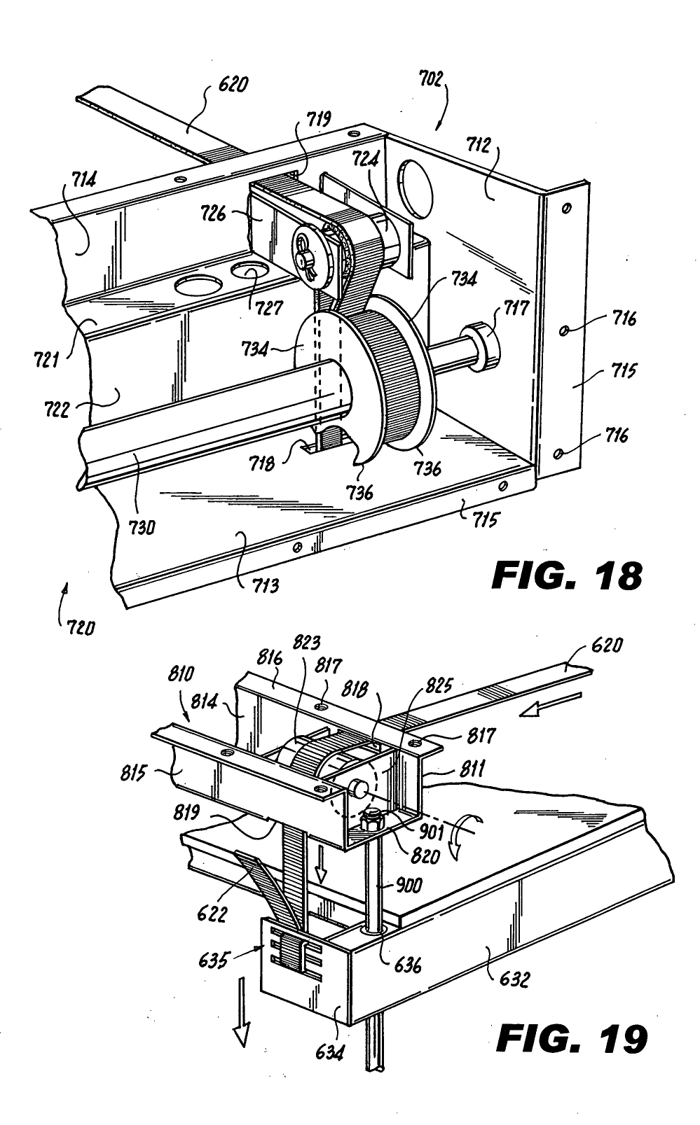

FIG. 16 is a sectional perspective view taken in section 15 of FIG. 14 of the first end 701 of the power side assembly 700 of the belt-driven bed lift mechanism 600; FIG. 17 is an exploded perspective view of the first belt 610 and the second belt 620 wrapped around the drive shaft 730 in the power side assembly 700 of the belt-driven bed lift mechanism 600; and FIG. 18 is a sectional perspective view taken in section 17 of FIG. 14 of the second end 702 of the power side assembly 700 of the belt-driven bed lift mechanism 600.

A first spool 733 and a second spool 734 are non-rotatably supported by the drive shaft 730 in the corner bracket 710. The first spool 733 is disposed near the first end plate 711 of the corner bracket 710, and the second spool 734 is disposed near the second end plate 712 of the corner bracket 710. A pair of discs 735 provided on the drive shaft 730 forms the first spool 733, and a pair of discs 736 provided on the drive shaft 730 forms the second spool 734. The first spool 733 and the second spool 734 are both provided on the drive shaft 730 and are therefore coaxial to each other.

A first guide wheel 723 and a second guide wheel 724 are also disposed within the enclosed space inside corner bracket 710. The first guide wheel 723 is supported by a bracket 725 mounted to the vertical surface 714 of the corner bracket 710 and is supported by the horizontal surface 721 of the step 720 inside the corner bracket 710. Likewise, the second guide wheel 724 is supported by a bracket 726 mounted to the vertical surface 714 of the corner bracket 710 and is supported by the horizontal surface 721 of the step 720 inside the corner bracket 710. The first guide wheel 723 and the second guide wheel 724 are coaxial to each other and are disposed above the first spool 733 and the second spool 734, toward the vertical surface 722 of the corner bracket 710.

FIG. 17 shows the configuration of the first belt 610 and the second belt 620 in the first spool 733. Another pair of the first belt 610 and the second belt 620 is wrapped similarly around the second spool 734. The discs 735, 736 of the first spool 733 and the second spool 734 ensure that the first belt 610 and the second belt 620 are aligned as the pair of belts 610, 620 are wound in an overlapping relationship to create a pleasing appearance and to prevent misalignment of the belts 610, 620 around the drive shaft 730.

The first belt 610 has a first end 611 and a second end 612; and the second belt 620 has a first end 621 and a second end 622. The drive shaft 730 includes a first slot 731 for inserting the first end 611 of the first belt 610 and a second slot 732 for inserting the first end 621 of the second belt 620. The first slot 731 and the second slot 732 are arranged in the drive shaft at a 180-degree angle from each other. The first ends 611, 621 of the belts 610, 620 are inserted into the slots 731, 732 in the drive shaft 730 to properly position the belts 610, 620 before the belts 610, 620 are wound around the drive shaft 730.

After the first ends 611, 621 of the first belt 610 and the second belt 620 are inserted into the respective slots 731, 732 in the drive shaft 730, the belts 610, 620 are wrapped around the drive shaft 730 so that each of the second belts 620 overlaps the first belt 610 that is paired to the particular second belt 620. Preferably, the belts 610, 620 are wrapped at least two times around the drive shaft 730; however, for clarity, the belts 610, 620 shown in FIG. 17 are wrapped less than one time around the drive shaft 730. Since the first belt 610 and the second belt 620 are wrapped around the drive shaft 730 in an overlapping manner as shown in FIG. 17, the first belt 610 and the second belt 620 can be unwound together at the same rate and at the same time.

The first guide wheel 723 and the second guide wheel 724 are aligned with the first spool 733 and the second spool 734, respectively, so that the first belt 610 and the second belt 620 can be wound over the first guide wheel 723 and the second guide wheel 724 after being unwound from the first and the second spools 733, 734. Thus, the first guide wheel 723 is disposed near the first end plate 711 of the corner bracket 710, and the second guide wheel 724 is disposed near the second end plate 712 of the corner bracket 710.

The belts 610, 620 are wound around the first and the second spools 733, 734 at least two times; however, the belts 610, 620 are wound around the first and the second guide wheels 723, 724 for less than a complete rotation.

As the second belt 620 overlaps the first belt 610, one of the pairs of the first and the second belts 610, 620 passes from the first spool 733 positioned below the first guide wheel 723 and then over the top of the first guide wheel 723. The other pair of the first and the second belts 610, 620 passes from the second spool 734 positioned below the second guide wheel 724 and then over the top of the second guide wheel 724, as shown in FIGS. 16-18.

Each of the first belts 610 loops over the top of the first and the second guide wheels 723, 724 and passes through a slot 718 in the horizontal surface 713 of the corner bracket 710. The second ends 612 of the first belts 610 are secured to the plates 634 mounted to the corners of the bed frame 631 and are positioned below the first and the second guide wheels 723, 724 in the corner bracket 710. As described above, the three slots 635 are provided in the plates 634 at the corners of the bed frame 631, and the second ends 612 of the first belts 610 are threaded through the slots 635 to secure the second ends 612 of the first belts 610 to the bed frame 631.

When the first and the second spools 733, 734 rotate to unwind the pairs of the first and second belts 610, 620, i.e., the first and the second spools 733, 734 rotate in the direction of arrow A of FIG. 16, the second ends 612 of each of the first belts 610 are lowered, thereby lowering the corresponding corners of the bed frame 631. When the first and the second spools 733, 734 rotate to wind up the first and second belts 610, 620, i.e., the first and the second spools 733, 734 rotate in the opposite direction from arrow A, the second ends 612 of each of the first belts 610 are raised, thereby raising the corresponding corners of the bed frame 631.

Each of the second belts 620 passes over the top of the first and the second guide wheels 723, 724 and passes through a slot 719 in the vertical surface 714 of the corner bracket 710. The second belt 620 extends over the bed frame 631 toward the slave side assembly 800.

The slave side assembly 800 has a first end 801 aligned with the first end 701 of the power side assembly 700 on the opposite side of the bed frame 631 and a second end 802 aligned with the second end 702 of the power side assembly 700 on the opposite side of the bed frame 631.

FIG. 19 is a perspective view of the first end 801 of the slave side assembly 800 of the belt-driven bed lift mechanism 600. The slave side assembly 800 includes a U-shaped bracket 810 that is parallel to the corner bracket 710 so that a first end 811 of the U-shaped bracket 810 at the first end 801 of the slave side assembly 800 is aligned with the first end plate 711 of the corner bracket 710, and a second end 812 of the U-shaped bracket 810 at the second end 802 of the slave side assembly 800 is aligned with the second end plate 712 of the corner bracket 710. The length of the U-shaped bracket 810 is approximately equal to the length of the corner bracket 710. The first and the second ends 811, 812 of the U-shaped bracket 810 are generally disposed near two corners of the bed frame 631.

The U-shaped bracket 810 has a base surface 813 and two parallel side surfaces (an inner vertical surface 814 toward the bed frame 631 and an outer vertical surface 815 toward the side wall 23 of the toy trailer 10) that are perpendicular to the base surface 813. Flanges 816 extend parallel to the base surface 813 from free ends of the side vertical surfaces 814, 815 and outward from the base surface 813 of the U-shaped bracket 810. Mounting holes 817 are provided on the flanges 816 for mounting the U-shaped bracket 810 to the ceiling 21 of the toy trailer 10.

The height of the U-shaped bracket 810 corresponds to the height of the vertical surface 714 of the corner bracket 710 so that when the bed 630 is in the fully raised position, the bed frame 631 abuts the underside of the base surface 813 of the U-shaped bracket 810 and the underside of the horizontal surface 721 of the step 720 in the corner bracket 710. When the height of the U-shaped bracket 810 equals the height of the vertical surface 714 of the corner bracket 710, the bed frame 631 is level in the fully raised position.

The U-shaped bracket 810 supports a first guide wheel 823 and a second guide wheel 824 disposed in respective brackets 825, 826 mounted between the base surface 813 and the vertical surfaces 814, 815 of the U-shaped bracket 810. The first and the second guide wheels 823, 824 are coaxial and are disposed at the first and the second ends 811, 812 of the U-shaped bracket 810, respectively. The first and the second guide wheels 823, 824 in the slave side assembly 800 are aligned at the same level as the first and the second guide wheels 723, 724 in the power side assembly 700. Thus, the second belt 620 is extended along the same height from the first and the second guide wheels 723, 724 in the corner bracket 710 to the first and the second guide wheels 823, 824 in the U-shaped bracket 810.

The U-shaped bracket 810 is provided with a pair of slots 818 in the inner vertical surface 814 to allow the pair of the second belts 620 to pass through as the second belts 620 are received from the first and the second guide wheels 723, 724 in the power side assembly 700. After entering the U-shaped bracket 810 through the slots 818 in the inner vertical surface 814, the second belts 629 wrap over the first and the second guide wheels 823, 824 in the U-shaped bracket 810.

The second belt 620 received from the first spool 733 in the power side assembly 700 passes over the top of the first guide wheel 823 supported by the U-shaped bracket 810. The second belt 620 then passes between the first guide wheel 823 and the outer vertical surface 815 of the U-shaped bracket 810 to pass through a slot 819 in the base surface 813 at the first end 811 of the U-shaped bracket 810. The second belt 610 from the second spool 734 in the power side assembly 700 passes over the top of the second guide wheel 834 in the U-shaped bracket 810. The second belt 620 then passes between the second guide wheel 834 and the outer vertical surface 815 of the U-shaped bracket 810 to pass through another slot 819 in the base surface 813 at the second end 812 of the U-shaped bracket 810.

The second ends 622 of the second belts 620 are secured to the respective corners of the bed frame 631 disposed under the first and the second guide wheels 823, 824 in the U-shaped bracket 810. The second ends 622 of the second belts 620 are secured to the plates 634 at the corners of the bed frame 631 positioned below the first and the second guide wheels 823, 824 in the U-shaped bracket 810. As described above, the three slots 635 are provided in the plates 634 at the corners of the bed frame 631, and the second ends 622 of the second belts 620 are threaded through the slots 635 to secure the second ends 622 of the second belts 620 to the bed frame 631.

When the first and the second spools 733, 734 in the power side assembly 700 rotate to unwind the two pairs of the first and the second belts 610, 620, i.e., the first and the second spools 733, 734 rotate in the direction of arrow A of FIG. 16, the second ends 622 of the second belts 620 are lowered, thereby lowering the respective corners of the bed frame 631 disposed under the first and the second guide wheels 823, 824 in the U-shaped bracket 810. When the first and the second spools 733, 734 rotate in the opposite direction to wind up the first and second belts 610, 620, the second ends 622 of the second belts 620 are raised, thereby raising the respective corners of the bed frame 631 disposed under the first and the second guide wheels 823, 824 in the U-shaped bracket 810.

Two guide rods 900 are connected to each of the power side assembly 700 and the slave side assembly 800 for guiding the bed frame 631 as it is raised and lowered by the bed lift mechanism 600. Each of the guide rods 900 has a top end 901 and a bottom end 902.

Each of the four guide rods 900 is disposed at a different corner of the bed frame 631. The top ends 901 of two of the guide rods 900 are fastened via holes 727 in the horizontal surface 721 of the step 720 of the corner bracket 710, and the top ends 901 of the other two guide rods 900 are fastened via holes 820 in the base surface 813 of the U-shaped bracket 810.

Each of the bottom ends 902 of the guide rods 900 are slidably coupled to a wall bracket 910. Two of the wall brackets 910 are fastened to one of the side walls 23 of the toy trailer 10, and the other two wall brackets 910 are fastened to the opposite side wall 23. The wall brackets 910 have a vertical portion 911 positioned flush against the respective side wall 23 and a horizontal portion 912 positioned perpendicular to the side wall 23. Mounting holes 913 in the vertical portion 911 are used to fasten the wall brackets 910 to the respective side wall 23. An alignment slot 914 in the horizontal portion 912 receives the bottom end 902 of the guide rod 910 so that the bottom end 902 of the guide rod 910 can slide within the alignment slots 914 perpendicular to the side walls 23.

Vertical guide holes 636 are provided in each of the corners of the bed frame 631, and the guide rods 900 are disposed inside the guide holes 636. Spacers (not shown) are disposed in the guide holes 636 and are preferably formed of UHMW (ultra high molecular weight) plastic or another type of material that allows the bed frame 631 to glide smoothly along the guide rods 900. As the bed frame 631 is lowered and raised by extending and retracting the pairs of the first and the second belts 610, 620, the guide rods 900 slide within the spacers and the guide holes 636 to guide the bed frame 631.

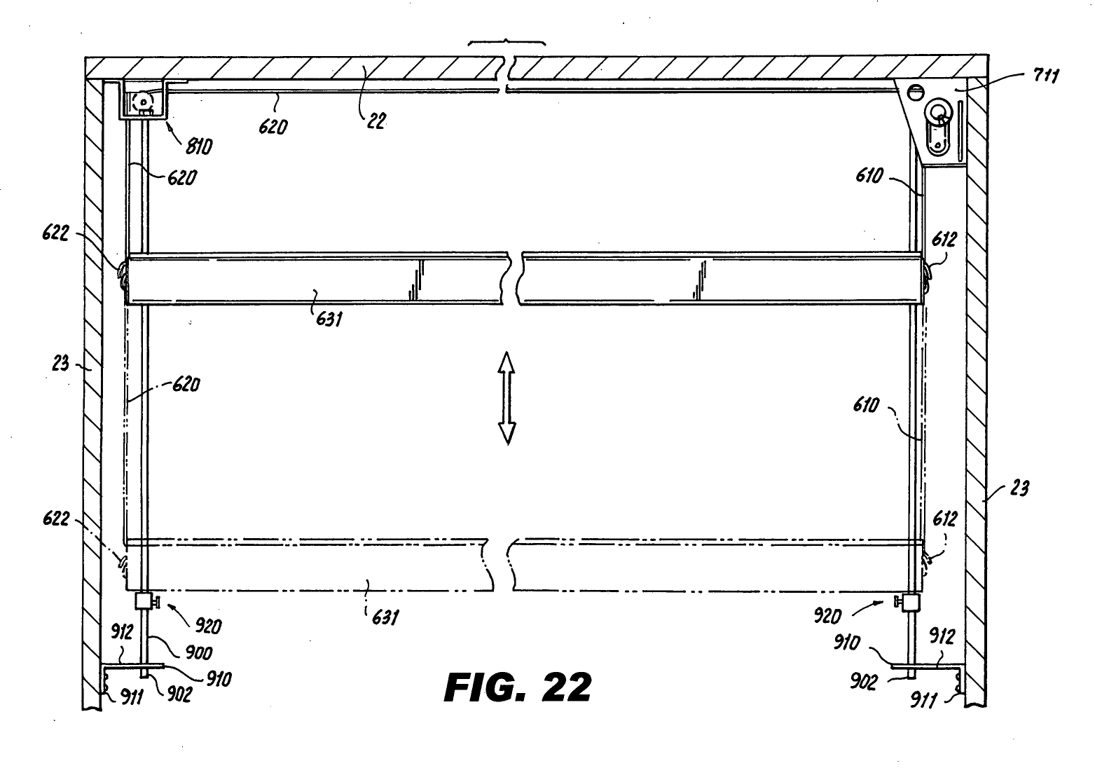

An adjustable stopper 920 is provided on each of the guide rods 900 for providing a lower limit as the bed frame 631 is lowered toward the floor 22 of the toy trailer 10. The stoppers 920 help support the weight of the bed 630 so that the bed lift mechanism 600 does not rely on the belts 610, 620 alone to support the bed 630. Once the bed frame 631 contacts one of the stoppers 920, as shown in the dashed-dot profile of FIG. 22, the respective corner of the bed frame 631 is prevented from being lowered any further. The stoppers 920 can be adjusted to various locations along the guide rods 900 by loosening the stoppers 920, sliding the stoppers 920 along the guide rods 900 to adjust their position, and then tightening the stoppers 920 to fix their position. The adjustable stoppers 920 are kept at the same level to maintain the bed 630 in a horizontal orientation and to prevent spoiling the appearance of the bed 630 and damaging the bed lift mechanism 600.

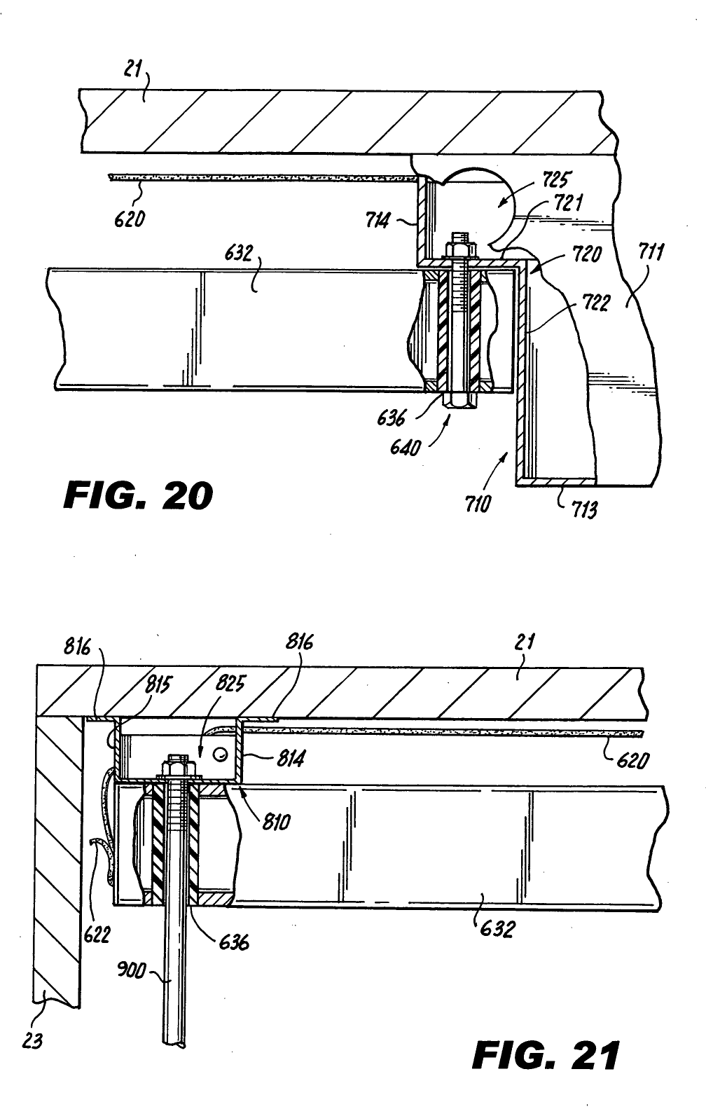

FIG. 20 is a sectional side view taken in section 19 of FIG. 13 of the bed 630 mounted to the power side assembly 700 during the installation of the belt-driven bed lift mechanism 600; and FIG. 21 is a sectional side view taken in section 20 of FIG. 13 of the bed 630 mounted to the slave side assembly 800 during the installation of the belt-driven bed lift mechanism 600. The installation of the belt-driven bed lift mechanism 600 will now be described.

Before mounting the power side assembly 700 and the slave side assembly 800 to the ceiling 21 and the side wall 23 of the toy trailer 10, the bed frame 631 is fastened to the power side assembly 700 and the slave side assembly 800 by inserting bolts 640, as shown in FIG. 20, through the guide holes 636 in the bed frame 631, the holes 727 in the corner bracket 710, and the holes 820 in the U-shaped bracket 810. The guide rods 900 are removed from the U-shaped bracket 810 and the corner bracket 710 at this stage of the assembly. Thus, the bed frame 631, the corner bracket 710, and the U-shaped bracket 810 are bolted together as one piece. The spools 733, 734 and the guide wheels 723, 724 are included in the corner bracket 710, the drive mechanism 650 is mounted to the corner bracket 710, and the guide wheels 823, 824 are included in the U-shaped bracket 810.

The bed frame 631, the corner bracket 710, and the U-shaped bracket 810 are raised as one piece to the ceiling 21 and fastened to the ceiling 21 and the side wall 23. The bolts 640 that were inserted into the guide holes 636 to fasten the bed frame 631 to the U-shaped bracket 810 and the corner bracket 710 are removed and replaced with the guide rods 900, as shown in FIG. 21, the top end 901 of which is inserted through the holes 727, 820 in the corner bracket 710 and the U-shaped bracket 810.

Before fastening the wall brackets 910 to the side walls 23, the stoppers 920 are moved close to the bottom ends 902 of the guide rods 900, as shown in as shown in the dashed-dot profile of FIG. 22, and the bed 630 is lowered using the bed lift mechanism 600 so that the bed 630 rests on the stoppers 920. While the bed 630 is in this lowered position, the wall brackets 910 are then fastened to the side walls 23, thereby ensuring that the guide rods 900 remain parallel to each other and perpendicular to the plane of the bed frame 631. The bed 630 can be raised back to the topmost position, and the stoppers 920 can be readjusted to set the lowest position for the bed 630 as preferred by the user.

If a motor is provided, the motor is hooked up to a power source before operating the bed lift mechanism.

A storage compartment such as the storage compartment 400 shown in FIG. 9 can be incorporated into the bed frame 631 of the belt-driven bed lift mechanism 600. When incorporating the storage compartment 400 into the belt-driven bed lift mechanism 600, the fixed portion 411, the hinged portion 414, and the hinge 417 are positioned with respect to the bed frame 631 so that the hinged portion 414 does not interfere with the second belts 620 which extend over the bed frame 631.

The operation of the belt-driven bed lift mechanism 600 will now be described with the bed 630 starting in a raised position.

FIG. 22 is a side view of the power side assembly 700 of the belt-driven bed lift mechanism 600. The lift mechanism 600 controls the movement of the bed 630 from a raised position (shown by the solid line of FIG. 22) to a lowered position (shown by the dashed-dot line of FIG. 22) for accessing the bed 630 in the toy trailer 10 after the ATVs have been removed from the rear section 20 of the toy trailer 10.

When the user wants to lower the bed 630, the user activates the lift mechanism 600 by operating the drive mechanism 650, which is attached to the power side assembly 700. The drive mechanism 650 is shown in FIGS. 15 and 16 as a motor.

As the user activates the motor, e.g., by flipping a switch or pressing a button, the motor causes the drive shaft 730 to rotate. Arrow A shows the direction of rotation of the drive shaft 730 for lowering the bed 630.

As the drive shaft 730 rotates in the direction of arrow A, the first belts 610 and the second belts 620 are deployed from each of the first spool 733 and the second spool 734. Each of the first belts 610 is positioned underneath one of the second belts 620.

One of the first belts 610 is guided over the first guide wheel 723 and passes through the slot 718 in the horizontal surface 713 near the first end plate 711 of the corner bracket 710. The other first belt 620 is guided over the second guide wheel 724 and passes through the slot 718 in the horizontal surface 718 near the second end plate 712 of the corner bracket 710. Each of the second ends 612 of the first belts 610 are secured to the bed 630 by threading the second ends 612 through the slots 635 in the plates 634 mounted to the corners of the side of the bed frame 631 closer to the power side assembly 700.

One of the second belts 620 is guided by the first guide wheel 723, passes through the slot 719 in the vertical surface 714 near the first end plate 711 in the corner bracket 710, and then extends to the opposite side of the bed frame 631 where it is guided over the top of the first guide wheel 823 in the U-shaped bracket 810. The other second belt 620 is guided by the second guide wheel 724, passes through the slot 719 in the vertical surface 714 near the second end plate 711 in the corner bracket 710, and then extends to the opposite side of the bed frame 631 where it is guided over the top of the second guide wheel 824 in the U-shaped bracket 810. Each of the second belts 620 are drawn through the slots 820 on the base surface 813 at the first and the second ends 811, 812 of the U-shaped bracket 810 and are secured to the corners of the side of the bed frame 631 closer to the slave side assembly 800.

Since the first belt 610 and the second belt 620 are wound onto the first and second spools 733, 734 in an overlapping manner, the belts 610, 620 are deployed at the same time and at the same rate, thereby ensuring that all four corners of the bed frame 631 are lowered at the same time and at the same rate.

After the bed 630 has been lowered to the preferred height, the user can activate the drive mechanism 650 to lift the bed 630 back to its original raised position. The operation of the bed lift mechanism 600 for raising the bed 630 is the same as the lowering operation described above except that the drive shaft 730 is rotated in the opposite direction from arrow A. As a result, the spools 733, 734 rotate in the opposite direction from arrow A, thereby causing the first and the second belts 610, 620 to wind back onto the spools 733, 734 until the bed 630 returns to the raised position or until the user stops the drive mechanism 650.

The advantages of the belt-driven belt lift mechanism 600 will now be described.

Since the first and the second spools 733, 734, the first and the second guide wheels 723, 724 in the power side assembly 700, and the first and the second guide wheels 823, 824 in the slave side assembly 800 are driven collectively by the single drive mechanism 650, there is no risk of binding in the lift mechanism 600. Furthermore, each of the first belts 610 is overlapped by one of the second belts 620 as they are wound around the spools 734, 734, thereby ensuring that the slave side assembly 700 is operated in synchronization with the power side assembly 800. Since each corner of the bed frame 631 is connected to one of the first belts 610 or the second belts 620, there is no danger that a corner of the bed frame 631 would move at a faster rate than another corner. There is also no danger that two different corners of the bed frame 631 would start or stop moving at different times. The movement of all of the corners of the bed frame 631 can be synchronized and driven at the same speed.

The bed frame 631 is also guided by the guide rods 900, thereby preventing misalignment of the bed 630. The bottom ends 902 of the guide rods 900 are slidingly engaged in the alignment slots 914 in the wall brackets 910, thereby allowing the guide rods 900 to find a center position that prevents binding of the bed frame 631 as it moves along the guide rods 900.

Furthermore, the spools 733, 734 and the guide wheels 723, 724, 823, 824 are not exposed and are housed within the corner bracket 710 or the U-shaped bracket 810 mounted to the ceiling 21 and side wall 23, thereby preventing anything such as fingers or clothing from being caught by the spools 733, 734 and the guide wheels 723, 724, 823, 824.

Since the power side assembly 700 is connected to the slave side assembly 800 by the second belts 620, the lift mechanism 600 can be adapted for use with bed frames 631 of varying lengths. By providing the second belts 620 of sufficient length, the lift mechanism 600 can be mounted to shorter or longer bed frames according to the user's preference.

A motor can be provided for powering the lift mechanism 600. Therefore, the lift mechanism 600 can be extended and retracted by pushing a button or by flipping a switch, for example. The motor can be provided with a manual override for connecting a hand crank. Furthermore, the motor can be replaced by a hand crank for manually powering the lift mechanism 600 without requiring a separate power source.

The bed lift mechanism 600 is easy to assemble and to install and can be bought separately to install into the toy trailer 10.

Having described embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A lift mechanism mounted to a support for raising and lowering a bed, the lift mechanism comprising:
a first gear assembly attached to one side of the bed, the first gear assembly comprising a first sprocket, a second sprocket, and a coupling gear coupled to each of the first sprocket and the second sprocket;
a drive mechanism for transferring rotational motion to the first sprocket in the first gear assembly, the first sprocket being operatively coupled to the second sprocket in the first gear assembly so that the rotational motion from first sprocket is transferred to the second sprocket;
a second gear assembly attached to another side of the bed, the second gear assembly comprising a third sprocket, a fourth sprocket, and a coupling gear coupled to each of the third sprocket and the fourth sprocket;
one of the sprockets in the first gear assembly being a selected sprocket for being operatively coupled to the third sprocket in the second gear assembly so that the rotational motion from the selected sprocket is transferred to the third sprocket;
the third sprocket being operatively coupled to the fourth sprocket in the second gear assembly so that the rotational motion from the third sprocket is transferred to the fourth sprocket; and
a first frame assembly and a second frame assembly mounted to the support, the first frame assembly comprising two track members coupled to the coupling gears in the first gear assembly, the second frame assembly comprising two track members coupled to the coupling gears of the second gear assembly,
wherein the first sprocket, the second sprocket, the third sprocket, and the fourth sprocket transfer the rotational motion to the respective coupling gears to controllably move the bed between a raised position and a lowered position.

2. The lift mechanism of claim 1, further comprising a drive shaft for transferring the rotational motion from the selected sprocket in the first gear assembly to the third sprocket in the second gear assembly.

3. The lift mechanism of claim 1, further comprising:
a first chain for transferring rotational motion from the first sprocket to the second sprocket in the first gear assembly; and
a second chain for transferring rotational motion from the third sprocket to the fourth sprocket in the second gear assembly.

4. The lift mechanism of claim 1, further comprising:
a drive sprocket connected to a drive shaft of the drive mechanism; and
a third chain for transferring the rotational motion from the drive sprocket to the first sprocket in the first gear assembly.

5. The lift mechanism of claim 1, further comprising:
a drive sprocket connected to a drive shaft of the drive mechanism;
a first chain for transferring the rotational motion from the drive sprocket to the first sprocket in the first gear assembly and for transferring the rotational motion from the first sprocket to the second sprocket in the first gear assembly; and
a second chain for transferring the rotational motion from the third sprocket to the fourth sprocket in the second gear assembly.

6. The lift mechanism of claim 2, wherein the drive shaft is enclosed within a side rail of the bed.

7. The lift mechanism of claim 1, wherein the support is a pair of opposing side walls in a toy trailer.

8. The lift mechanism of claim 1, further comprising:
a first cross bar supporting the first gear assembly;
a second cross bar supporting the second gear assembly; and
a pair of first guides mounted to the first cross bar and a pair of second guides mounted to the second cross bar,
wherein each of the first guides is coupled to one of the track members in the first frame assembly, each of the second guides is coupled to one of the track members in the second frame assembly, and each of the first guides and the second guides contacts the respective track member.

9. The lift mechanism of claim 8, further comprising:
first gear covers extending from the first cross bar for covering the coupling gears of the first gear assembly; and
second gear covers extending from the second cross bar for covering the coupling gears of the second gear assembly.

10. The lift mechanism of claim 1, further comprising a storage compartment incorporated into a bed frame of the bed.

11. The lift mechanism of claim 1, further comprising:
a first cross bar supporting the first gear assembly;
a second cross bar supporting the second gear assembly; and
a controllably rotatable locking lever mounted to one of the cross bars, the locking lever comprising an end that engages one of the track members.

12. A lift mechanism mounted to a support for controllably moving a bed, the lift mechanism comprising:
at least one first drive member connected to a side of the bed, one of the at least one first drive member being a driven first drive member;
at least one first guide member disposed on a surface of the support, the at least one first guide member having a plurality of first drive features formed as a part thereof;
at least one second drive member connected to another side of the bed, one of the at least one second drive member being a driven second drive member;
at least one second guide member disposed on another surface of the support, the at least one second guide member having a plurality of second drive features formed as a part thereof;
a drive mechanism for driving the driven first drive member; and
a drive shaft enclosed within a bed frame of the bed, the drive shaft operatively coupling the driven first drive member to the driven second drive member so that movement of the driven first drive member results in the driven first drive member and the driven second drive member being driven together,
wherein the at least one first drive member complements and engages the first drive features and the at least one second drive member complements and engages the second drive features to controllably move the bed between a raised position and a lowered position under action of the drive mechanism.

13. The lift mechanism of claim 12, further comprising:
one of the at least one first drive member being a slave first drive member;
one of the at least one second drive member being a slave second drive member;
a first chain for operably coupling the driven first drive member to the slave first drive member; and
a second chain for operably coupling the driven second drive member to the slave second drive member.

14. The lift mechanism of claim 12, further comprising:
a drive sprocket connected to a drive shaft of the drive mechanism; and
a third chain for operably coupling the drive sprocket to the driven first drive member.

15. The lift mechanism of claim 12, further comprising:
one of the at least one first drive member being a slave first drive member;
one of the at least one second drive member being a slave second drive member;
a drive sprocket connected to a drive shaft of the drive mechanism;
a first chain for operably coupling the drive sprocket to the driven first drive member and for operably coupling the driven first drive member to the slave first drive member; and
a second chain for operably coupling the driven second drive member to the slave second drive member.

16. The lift mechanism of claim 12, wherein the drive shaft is enclosed within a side rail of the bed frame.

17. The lift mechanism of claim 12, wherein the support is a pair of opposing side walls in a toy trailer.

18. The lift mechanism of claim 12, further comprising:
a first cross bar supporting the at least one first drive member;
a second cross bar supporting the at least one second drive member;
at least one first guide mounted to the first cross bar and at least one second guide mounted to the second cross bar,
at least one first gear cover extending from the first cross bar for covering the at least one first drive member; and
at least one second gear cover extending from the second cross bar for covering the at least one second drive member,
wherein the at least one first guide is coupled to and slides on the at least one first guide member, and the at least one second guide is coupled to and contacts the at least one second guide member.

19. The lift mechanism of claim 12, further comprising:
a first cross bar supporting the at least one first drive member;
a second cross bar supporting the at least one second drive member; and
a controllably rotatable locking lever mounted to one of the cross bars, the locking lever comprising an end that engages the first guide member.

20. A lift mechanism mounted to a support for controllably moving a bed, the lift mechanism comprising:
a first cross bar mounted to a side of the bed;
a second cross bar mounted to another side of the bed;
at least one first drive member and at least one first guide block provided on the first cross bar, one of the at least one first drive member being a driven first drive member;
at least one second drive member and at least one second guide block provided on the second cross bar, one of the at least one second drive member being a driven second drive member;
at least one first guide member disposed on a surface of the support, the at least one first guide member having a plurality of first drive features formed as a part thereof;
at least one second guide member disposed on an opposite surface of the support, the at least one second guide member having a plurality of second drive features formed as a part thereof;
the at least one first guide block being coupled to the at least one first guide member, the at least one second guide block being coupled to the at least one second guide member, the first and the second guide blocks sliding along a lip of the respective first guide member and the respective second guide member;
a drive mechanism for driving one of the first drive members; and
a drive shaft operatively coupling the driven first drive member to the driven second drive member so that movement of the driven first drive member results in the driven first drive member and the driven second drive member being driven together,
wherein the at least one first drive member complements and engages the first drive features and the at least one second drive member complements and engages the second drive features to controllably move the bed between a raised position and a lowered position under action of the drive mechanism.

21. The lift mechanism of claim 20, further comprising:
one of the at least one first drive member being a slave first drive member;
one of the at least one second drive member being a slave second drive member;
a first chain for operably coupling the driven first drive member to the slave first drive member; and
a second chain for operably coupling the driven second drive member to the slave second drive member.

22. The lift mechanism of claim 20, further comprising:
a drive sprocket connected to a drive shaft of the drive mechanism; and
a third chain for operably coupling the drive sprocket to the driven first drive member.

23. The lift mechanism of claim 20, further comprising:
one of the at least one first drive member being a slave first drive member;
one of the at least one second drive member being a slave second drive member;
a drive sprocket connected to a drive shaft of the drive mechanism;
a first chain for operably coupling the drive sprocket to the driven first drive member and for operably coupling the driven first drive member to the slave first drive member; and
a second chain for operably coupling the driven second drive member to the slave second drive member.

24. The lift mechanism of claim 20, further comprising:
at least one first gear cover extending from the first cross bar for covering the at least one first drive member; and
at least one second gear cover extending from the second cross bar for covering the at least one second drive member.

25. The lift mechanism of claim 20, further comprising a controllably rotatable locking lever mounted to one of the cross bars, the locking lever comprising an end that engages the first guide member.

26. A lift mechanism mounted to a support for controllably moving a bed, the lift mechanism comprising:
at least one first drive member connected to a side of the bed, one of the at least one first drive member being a driven first drive member;
at least one first guide member disposed on a surface of the support, the at least one first guide member having a plurality of first drive features formed as a part thereof;
at least one second drive member connected to another side of the bed, one of the at least one second drive member being a driven second drive member;
at least one second guide member disposed on another surface of the support, the at least one second guide member having a plurality of second drive features formed as a part thereof;
a drive mechanism for driving the driven first drive member;
a drive shaft operatively coupling the driven first drive member to the driven second drive member so that movement of the driven first drive member results in the driven first drive member and the driven second drive member being driven together; and
a storage compartment incorporated into a bed frame of the bed,
wherein the at least one first drive member complements and engages the first drive features and the at least one second drive member complements and engages the second drive features to controllably move the bed between a raised position and a lowered position under action of the drive mechanism.

27. The lift mechanism of claim 26, wherein the storage compartment is enclosed within two cross bars of the bed frame and two side rails of the bed frame.

28. The lift mechanism of claim 27, wherein the storage compartment includes a hinged portion of a panel covering the storage compartment and a mattress of the bed is disposed on top of the hinged portion of the panel.

29. The lift mechanism of claim 28, wherein linear actuators controllably move the hinged portion of the panel to open and close the storage compartment.

30. The lift mechanism of claim 26, further comprising:
one of the at least one first drive member being a slave first drive member;
one of the at least one second drive member being a slave second drive member;
a first chain for operably coupling the driven first drive member to the slave first drive member; and
a second chain for operably coupling the driven second drive member to the slave second drive member.

31. The lift mechanism of claim 26, further comprising:
a drive sprocket connected to a drive shaft of the drive mechanism; and
a third chain for operably coupling the drive sprocket to the driven first drive member.

32. The lift mechanism of claim 26, further comprising:
one of the at least one first drive member being a slave first drive member;
one of the at least one second drive member being a slave second drive member;
a drive sprocket connected to a drive shaft of the drive mechanism;
a first chain for operably coupling the drive sprocket to the driven first drive member and for operably coupling the driven first drive member to the slave first drive member; and
a second chain for operably coupling the driven second drive member to the slave second drive member.

33. The lift mechanism of claim 26, wherein the drive shaft is enclosed within a side rail of the bed frame that includes a slot formed therein to permit access to the drive shaft.

34. The lift mechanism of claim 26, further comprising:
a first cross bar supporting the at least one first drive member;
a second cross bar supporting the at least one second drive member;
at least one first guide mounted to the first cross bar and at least one second guide mounted to the second cross bar,
at least one first gear cover extending from the first cross bar for covering the at least one first drive member; and
at least one second gear cover extending from the second cross bar for covering the at least one second drive member.
wherein the at least one first guide is coupled to and contacts the at least one first guide member, and the at least one second guide is coupled to and contacts the at least one second guide member.

35. The lift mechanism of claim 26, further comprising:
a first cross bar supporting the at least one first drive member;
a second cross bar supporting the at least one second drive member; and
a controllably rotatable locking lever mounted to one of the cross bars, the locking lever comprising an end that engages the first guide member.

36. A method for positioning a bed between a raised position and a lowered position, the method comprising the steps of:
attaching a first gear assembly to one side of the bed, the first gear assembly comprising a first sprocket, a second sprocket, and coupling gears coupled to each of the first sprocket and the second sprocket;
transferring a rotational motion from a drive mechanism to the first sprocket in the first gear assembly;
coupling the first sprocket to the second sprocket in the first gear assembly so that the rotational motion from first sprocket is transferred to the second sprocket;
attaching a second gear assembly to another side of the bed, the second gear assembly comprising a third sprocket, a fourth sprocket, and coupling gears coupled to each of the third sprocket and the fourth sprocket;
coupling a selected sprocket in the first gear assembly to the third sprocket in the second gear assembly, the selected sprocket in the first gear assembly so that the rotational motion from the selected sprocket is transferred to the third sprocket;
coupling the third sprocket to the fourth sprocket in the second gear assembly so that the rotational motion from the third sprocket is transferred to the fourth sprocket;
mounting a first frame assembly and a second frame assembly to the support, the first frame assembly comprising two track members coupled to the coupling gears in the first gear assembly, the second frame assembly comprising two track members coupled to the coupling gears of the second gear assembly; and
transferring the rotational motion from the first sprocket, the second sprocket, the third sprocket, and the fourth sprocket to the respective coupling gears to controllably move the bed between a raised position and a lowered position.

37. The method of claim 36, further comprising the step of transferring the rotational motion from one of the sprockets in the first gear assembly to the third sprocket in the second gear assembly.

38. The method of claim 36, further comprising the step of transferring the rotational motion from a drive sprocket connected to a drive shaft of the drive mechanism to the first sprocket in the first gear assembly.

39. The method of claim 36, further comprising the steps of:
supporting the first gear assembly with a first cross bar;
supporting the second gear assembly with a second cross bar;
mounting a pair of first guides to the first cross bar;
mounting a pair of second guides to the second cross bar;
coupling each of the first guides to one of the track members in the first frame assembly;
coupling each of the second guides to one of the track members in the second frame assembly;
contacting each of the first guides and the second guides with the respective track member.

40. The lift mechanism of claim 36, further comprising the steps of:
rotating a locking lever in one direction to engage the locking lever with one of the track members; and
rotating the locking lever in an opposite direction to disengage the lever from the track member.

41. A lift mechanism mounted to a support for controllably moving a bed, the lift mechanism comprising:
at least one bracket mounted to a support;
a drive mechanism mounted to the at least one bracket;
at least one spool supported by the at least one bracket; and
a first belt and a second belt wound onto the spool, the second belt overlapping the first belt,
wherein an end of the first belt and an end of the second belt are secured to different locations of the bed, and
the first belt and the second belts are wound or unwound from the spool under action of the drive mechanism to controllably move the bed between a raised position and a lowered position.

42. The lift mechanism of claim 41, further comprising a storage compartment incorporated into a bed frame of the bed.

43. The lift mechanism of claim 41, wherein the support for mounting the at least one bracket is at least one of a ceiling and a side wall of a vehicle.

44. A lift mechanism mounted to a support for controllably moving a bed, the lift mechanism comprising:
a first cross bar mounted to a side of the bed;
a second cross bar mounted to another side of the bed;
at least one first drive member and at least one first roller wheel provided on the first cross bar, one of the at least one first drive member being a driven first drive member;
at least one second drive member and at least one second roller wheel provided on the second cross bar, one of the at least one second drive member being a driven second drive member;
at least one first guide member disposed on a surface of the support, the at least one first guide member having a plurality of first drive features formed as a part thereof;
at least one second guide member disposed on an opposite surface of the support, the at least one second guide member having a plurality of second drive features formed as a part thereof;
the at least one first roller wheel being coupled to the at least one first guide member, the at least one second roller wheel being coupled to the at least one second guide member, the first and the second roller wheels rolling along a side of the respective first guide member and the respective second guide member;
a drive mechanism for driving one of the first drive members; and
a drive shaft operatively coupling the driven first drive member to the driven second drive member so that movement of the driven first drive member results in the driven first drive member and the driven second drive member being driven together,
wherein the at least one first drive member complements and engages the first drive features and the at least one second drive member complements and engages the second drive features to controllably move the bed between a raised position and a lowered position under action of the drive mechanism.

45. The lift mechanism of claim 44, further comprising a controllably rotatable locking lever mounted to one of the cross bars, the locking lever comprising an end that engages the first guide member.
